(19) United States
(12) Patent Application Publication
(10) Pub. No.: US 2025/0368224 A1
(43) Pub. Date: Dec. 4, 2025

(54) DETECTION OF BLOCKED LANES IN DRIVING APPLICATIONS

(71) Applicant: Waymo LLC, Mountain View, CA (US)

(72) Inventors: Aishwarya Parasuram, Sunnyvale, CA (US); Shangxuan Wu, Sunnyvale, CA (US); Zheng Sun, Saratoga, CA (US); Kazu Otani, US, AZ (US); Carlos Richard Rivera, Milpitas, CA (US); Sik Yu Poon, San Francisco, CA (US); Qichi Yang, Los Altos, CA (US); Kevin Sheu, San Jose, CA (US); Tian Lan, Union City, CA (US)

(21) Appl. No.: 18/676,196

(22) Filed: May 28, 2024

(51) Int. Cl. B60W 60/00; B60W 50/00; G06N 3/0455

(52) U.S. Cl. CPC B60W 60/0011; B60W 50/00; G06N 3/0455; B60W 2420/403; B60W 2420/408; B60W 2552/50; B60W 2554/402; B60W 2554/4044; B60W 2556/40

(57) ABSTRACT

The disclosed systems and techniques facilitate efficient detection and navigation of blocked lanes in driving environments. The disclosed techniques include obtaining sensing data associated with a driving environment and identifying obstruction marker(s) associated with the driving environment based on the sensing data. The techniques further include obtaining a first determination whether an object, represented in the sensing data, is obstructing traffic, the first determination based on the obstruction marker(s). The techniques further include obtaining a second determination whether the object is obstructing traffic by applying a machine learning model to an input that includes at least a portion of the sensing data. The techniques further include identifying blocked lane(s) using the obtained determinations and modifying, in view of the blocked lane(s), a driving path of the vehicle.

### TECHNICAL FIELD

The instant specification generally relates to autonomous vehicles. More specifically, the instant specification relates to detection of blocked lanes in driving environments.

### BACKGROUND

An autonomous (fully or partially self-driving) vehicle (AV) operates by sensing an outside environment with various electromagnetic (e.g., radar and optical) and non-electromagnetic (e.g., audio and humidity) sensors. Some autonomous vehicles chart a driving path through the environment based on the sensed data. The driving path can be determined based on Global Positioning System (GPS) data and road map data. While the GPS and the road map data can provide information about static aspects of the environment (buildings, street layouts, road closures, etc.), dynamic information (such as information about other vehicles, pedestrians, streetlights, etc.) is obtained from contemporaneously collected sensing data. Precision and safety of the driving path and of the speed regime selected by the autonomous vehicle depend on timely and accurate identification of various objects present in the outside environment and on the ability of a driving algorithm to process the information about the environment and to provide correct instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example vehicle capable of deploying a processing pipeline for detection and navigation of semantically blocked lanes (BLs) in driving environments, in accordance with some implementations of the present disclosure.

FIG. 2 is a diagram illustrating an example system architecture that can be used for training and deployment of a BL processing pipeline capable of identifying and navigating BLs in driving environments, in accordance with some implementations of the present disclosure.

FIG. 3 illustrates a data flow of an example BL processing pipeline capable of efficient identification and navigation of blocked and shifted lanes in driving environments, in accordance with some implementations of the present disclosure.

FIG. 4 illustrates an example architecture of a block detection machine learning model (MLM) capable of identifying objects as blocking at least a portion of a driving environment, in accordance with some implementations of the present disclosure.

FIG. 5 illustrates an example architecture of a vision language model capable of identifying objects as blocking at least a portion of a driving environment using visual images of a driving environment, in accordance with some implementations of the present disclosure.

FIG. 6A illustrates schematically identification of blocked lanes in an example driving environment of an intersection, in accordance with some implementations of the present disclosure.

FIG. 6B illustrates schematically navigating a situation with a blocked lane in the direction of travel of a vehicle, in accordance with some implementations of the present disclosure.

FIG. 6C illustrates schematically navigating a situation with a blocked lane of travel of a vehicle, in accordance with some implementations of the present disclosure.

FIG. 6D illustrates schematically navigating a situation with multiple blocked lanes in the direction of travel of a vehicle, in accordance with some implementations of the present disclosure.

FIG. 6E illustrates schematically identification of blocked lanes in a situation of objects stopped in a staggered pattern, in accordance with some implementations of the present disclosure.

FIG. 6F illustrates schematically identification of blocked lanes using multiple BL detection techniques, in accordance with some implementations of the present disclosure.

FIG. 6G is a schematic illustration of a longitudinal cost that can be used by a planner of a BL processing pipeline for BL navigation, in accordance with some implementations of the present disclosure.

FIG. 6H is a schematic illustration of a lateral cost that can be used by a planner of a BL processing pipeline for BL navigation, in accordance with some implementations of the present disclosure.

FIG. 7 illustrates an example architecture of a BL detection MLM capable of end-to-end (EE) identification of blocked and traversable lanes in driving environments, in accordance with some implementations of the present disclosure.

FIG. 8 illustrates an example method of deploying a BL processing pipeline for identifying and navigating BLs in driving environments, in accordance with some implementations of the present disclosure.

FIG. 9 depicts a block diagram of an example computer device capable of a training and/or deploying a BL processing pipeline for identifying and navigating BLs in driving environments, in accordance with some implementations of the present disclosure.

### SUMMARY

In one implementation, disclosed is a system that includes a sensing system of a vehicle and a data processing system of the vehicle. The sensing system is configured to acquire sensing data associated with a driving environment. The data processing system is configured to identify one or more obstruction markers associated with the driving environment based on the sensing data and obtain, based on the one or more obstruction markers, a first determination whether an object is obstructing traffic in the driving environment. The data processing system is further configured to obtain a second determination whether the object is obstructing traffic in the driving environment by applying a first machine learning model (MLM) to a first input that includes at least a portion of the sensing data. The data processing system is further configured to identify one or more blocked lanes caused by the object by using the first determination and the second determination and modify, in view of the one or more blocked lanes, a driving path of the vehicle in the driving environment.

In another implementation, disclosed is a method that includes obtaining, using a sensing system of a vehicle, sensing data associated with a driving environment and identifying, using a processing device, one or more obstruction markers associated with the driving environment based on the sensing data. The method further includes obtaining, using a processing device, a first determination whether an object, represented in the sensing data, is obstructing traffic in the driving environment, wherein the first determination is based on the one or more obstruction markers. The method further includes obtaining a second determination whether the object is obstructing traffic in the driving environment by applying a first MLM to a first input that includes at least a portion of the sensing data. The method further includes identifying one or more blocked lanes caused by the object by using the first determination and the second determination, and modifying, in view of the one or more blocked lanes, a driving path of the vehicle in the driving environment.

In yet another implementation, disclosed is an autonomous vehicle that includes a sensing system, a data processing system, and a driving control system. The sensing system is configured to acquire sensing data associated with a driving environment, the sensing data including one or more of (i) one or more camera images of the driving environment, (ii) one or more lidar images of the driving environment, or (iii) one or more radar images of the driving environment. The data processing system is configured to identify one or more obstruction markers associated with the driving environment based on the sensing data and obtain, based on the one or more obstruction markers, a first determination whether an object, represented in the sensing data, is obstructing traffic in the driving environment. The data processing system is further configured to obtain a second determination whether the object is obstructing traffic in the driving environment by applying a first MLM to a first input that includes at least a portion of the sensing data. The data processing system is further configured to identify one or more blocked lanes caused by the object by using the first determination and the second determination and modify, in view of the one or more blocked lanes, a driving path of the vehicle in the driving environment. The driving control system is configured to direct the autonomous vehicle on the modified driving path.

### DETAILED DESCRIPTION

An autonomous vehicle or a vehicle deploying various advanced driver-assistance features can use multiple sensor modalities to facilitate detection of objects in outside environments and predict future trajectories of such objects. Sensors can include radio detection and ranging (radar) sensors, light detection and ranging (lidar) sensors, digital cameras, ultrasonic sensors, positional sensors, and the like. Different types of sensors can provide different and complementary benefits. For example, radars and lidars emit electromagnetic signals (radio signals or optical signals) that reflect from the objects and carry back information about distances to the objects (e.g., determined from time of flight of the signals) and velocities of the objects (e.g., from the Doppler shift of the frequencies of the reflected signals). Radars and lidars can scan an entire 360-degree view by using a series of consecutive sensing frames. Sensing frames can include numerous reflections covering the outside environment in a dense grid of return points. Each return point can be associated with the distance to the corresponding reflecting object and a radial velocity (a component of the velocity along the line of sight) of the reflecting object.

Lidars, by virtue of their sub-micron or micron optical wavelengths, have high spatial resolution, which facilitates obtaining many closely-spaced return points from the same object. This enables accurate detection and tracking of objects once the objects are within the reach of lidar sensors. Radar sensors are inexpensive, require less maintenance than lidar sensors, have a larger working range of distances, and have a good tolerance of adverse weather conditions. Cameras (e.g., photographic or video cameras) capture two-dimensional projections of the three-dimensional outside space onto an image plane (or some other non-planar imaging surface) and can acquire high resolution images at both shorter distances and longer distances.

Various sensors of a vehicle's sensing system (e.g., lidars, radars, cameras, and/or other sensors, such as sonars) capture complementary depictions of objects located in the environment of the vehicle. The vehicle's perception system identifies objects based on objects' appearance, state of motion, trajectory of the objects, and/or other properties. For example, lidars can accurately map a shape of one or more objects (using multiple return points) and can further determine distances to those objects and/or the objects' velocities. Cameras can obtain visual images of the objects. The perception system can map shapes and locations (obtained from lidar data) of various objects in the environment to their visual depictions (obtained from camera data) and perform a number of computer vision operations, such as segmenting (clustering) sensing data among individual objects (clusters), identifying types/makes/models/etc. of the individual objects, and/or the like. A prediction and planning system can track motion (including but not limited to locations and velocities) of various objects across multiple times and then extrapolate the previously observed motion into the future. This predicted motion can be used by various vehicle control systems to select a driving path that takes these objects into account, e.g., avoids the objects, slows the vehicle down in the presence of the objects, and/or takes some other suitable actions.

In addition to detection of animate objects, the sensing system of a vehicle serves the important purpose of identifying various semantic information, such as markings on a road pavement (e.g., boundaries of driving lanes, locations of stop lines, etc.), traffic lights, traffic signs, indications of traffic lanes that are temporarily blocked to traffic or lanes with temporarily modified layout, e.g., shifted lanes. For example, a lane can be closed off to traffic by a vehicle pursuant to a blocking intent, e.g., an emergency response vehicle blocking a crime scene, or accidentally (without a specific blocking intent but nonetheless requiring a substantial time to clear), e.g., by a crashed vehicle and/or vehicle otherwise disabled in the middle of the road, such as a stalled bus blocking an intersection. Such occurrences can lead to one or more blocked lanes (BLs).

Even for a human driver, understanding which lanes are closed, which lanes are open, and which lanes are shifted can be challenging since emergency responders can, alternatively, divert all traffic on a detour, channel traffic to particular lane(s), establish a temporary reversible lane for managing vehicle flow in both directions of the traffic, and/or the like. Since BLs are usually transient (lasting from several minutes to several hours), they typically are not captured and/or not marked on maps. For some autonomous vehicles that rely on maps for general navigation, a reliance on sensor data is needed to identify and navigate such blocked lanes. In some embodiments, marking or semantically identifying a BL can be done with a diverse set of features (markers) that can be very case-specific, e.g., a police car or fire truck blocking the street, emergency crew members walking on the roadway, a “No Traffic” (or similar) temporary sign placed to mark BL(s), a caution tape set across one or more BLs, a water hose connected to a hydrant or fire truck and lying on the ground, a set of flares/lights marking a boundary of an undrivable portion of the road, emergency crew members walking on the roadway, and/or the like.

The existing techniques of BL detection usually rely on a set of pre-programmed situation-specific rules, e.g., presence of police car with emergency lights turned on, presence of cones, plastic barriers, caution tape, and/or the like. Situation-specific rules, however, do not fully capture broader contexts of driving scenes and can result in false positives or missed BLs. For example, a stopped or even moving police car can be mistaken for a blocking vehicle. Similarly, a person in a safety uniform jaywalking across the roadway can be mistaken for a member of a fire crew, triggering an unwanted response, e.g., causing the autonomous vehicle to block the traffic. Formulating all possible scenarios and exceptions using situation-specific rules to cover a practically unlimited multitude of real-world situations is a formidable task.

Aspects and implementations of the present disclosure address these and other challenges of the modern perception technology by disclosing a BL processing pipeline for comprehensive and efficient identification of blocked and shifted lanes in driving environments and determination of driving paths of autonomous vehicles. A BL processing pipeline can deploy a combination of trained machine learning models (MLMs) and/or learned heuristics to identify a layout of drivable lanes that are intentionally or accidentally blocked, redirected, and/or otherwise modified by emergence vehicles and/or other objects. In some implementations, a lane is identified as blocked not only in the cases of actual physical blockages (e.g., by a car, barrier, officer, etc.), but also in the instances of implicit blockages, when a human driver would understand a lane as non-traversable (e.g., a lane that is adjacent to an emergency vehicle with flashing lights). In some implementations of the disclosure, a BL processing pipeline can include multiple stages of processing. The first-block detection-stage can identify whether one or more objects block at least a portion of the roadway, e.g., a police vehicle closing one or more lanes near an accident scene, a crime scene, a hazardous material spill, and/or the like. The block detection stage can use static roadgraph (map) data and dynamic sensing data acquired by a sensing system of the vehicle, including camera images, lidar images, radar images, audio data (e.g., collected by on-board microphones), and/or the like. The raw data collected by the sensing system can be processed by a perception system that tracks changes of the driving environment with time, including but not limited to identifying status of traffic lights and tracking motion (trajectories) of various objects (vehicles, pedestrians, animals, etc.). The perception system of the vehicle can deploy multiple subsystems that use the processed data (which, in some instances, can be augmented with the raw data) to detect that a specific object (e.g., a police car) is purposely blocking the roadway (as opposed to stopping for a reason of malfunction, running out of gas or electricity, and/or the like).

In some implementations, such subsystems can include a block detection MLM that processes scene's roadgraph features, state of traffic lights, tracks of objects, and/or other input data, and classifies various driving situations as blocking (or not blocking) traffic among a number of defined (during training) categories, e.g., blocking, normal motion, parking, entering traffic, accident, and/or the like. The subsystems of the block detection stage can further include a vision language model (VLM) trained to process camera images and associate camera images with various textual categories of blocking events (e.g., blocking, normal motion, and/or the like). Additionally, the block detection stage can include a heuristics module that looks for various predetermined cues in the outputs of the perception system, e.g., presence of emergency vehicles, flashing lights, sirens, police tape, cones, flares, and/or other indicators of BLs. The heuristics module, the block detection MLM, and the VLM can output independent determinations whether various objects in the driving environment are in a blocking state.

The output of the first (block detection) stage indicating presence of one or more objects blocking at least a part of the roadway can be used by a second-BL identification-stage that uses a heuristic-based module to determine a lane map indicating lanes as blocked, normal, shifted, and/or the like. For example, a location, type, size, and orientation of the object identified as blocking the traffic can be used to determine specific lanes that are blocked, lanes that are not blocked, and/or the lanes that are shifted (referred to as a lane map herein). For example, a police vehicle of a certain size can be associated with a bounding box whose intersection with traffic lanes causes the lanes to be classified as BLs. The size of the bounding box can further depend on the orientation of the police car relative to the traffic lanes, e.g., a police car straddling a boundary between two lanes can be assigned, for the purpose of BL identification, a bigger bounding box than the same police car positioned entirely within a single lane, a car positioned perpendicularly to the traffic lanes can be assigned a bigger bounding box than the same car oriented along the traffic, and/so on.

In some implementations, the BL identification stage can include one or more MLMs, e.g., a BL detection MLM and a roadgraph drivability MLM. The BL detection MLM can perform end-to-end (E2E) processing of features representative of the static roadgraph, features representative of dynamically-tracked (based on sensing data) lanes, features indicative of blocking accessories (e.g., cones, tape, barriers, and/or the like), features representative of a type of a blocking object (e.g., presence of sirens, flashing lights, etc.), and/or the like, and directly output (without the intermediate stage of block detection) a second lane map with classification of lanes as blocked/normal/shifted/etc. The roadgraph drivability MLM can process sensing data of multiple modalities (e.g., lidar/radar/camera/etc.) together with the static roadgraph information and output a heatmap of probabilities P(x, y) indicative of the likelihood that various points x, y of the driving environment are blocked. The heatmap of probabilities overlaid over the roadgraph can be used to generate a third lane map identifying blocked lanes of the driving environment.

The outputs of the second (BL identification) stage, including multiple lane maps identified using various techniques, can be aggregated to determine a final map of drivable areas of the roadway. In some implementations, if a given lane is identified as blocked by any of the heuristics module, the BL detection MLM, or the roadgraph drivability MLM, that lane can be classified as blocked. In some implementations, a lane is classified as blocked if at least two of the heuristics module, the BL detection MLM, and/or the roadgraph drivability MLM identify the lane as blocked.

The final lane map can be used as an input into a third-BL navigation-stage that determines an optimal trajectory for the vehicle to navigate the driving environment with the identified BLs. For example, if some of the lanes are open in the direction of the vehicle's travel, a planner system of the vehicle can cause the vehicle control system to direct the vehicle to the open lanes. If lanes are shifted, the planner can identify entry and exit waypoints of the lane-shifted portion of the driving environment, chart a trajectory between one of the entry waypoints and one of the exit waypoints and cause the vehicle control system to direct the vehicle to the charted trajectory. If no lanes are available in the direction of travel of the vehicle, the planner can direct the vehicle to one of the lanes that remain open (e.g., making a right turn, left turn, U-turn, etc.) If no lanes remain open, the planner can direct the vehicle control system to perform a multi-point turn and/or a similar maneuver that reverses the vehicle's direction of motion. In various such instances where a previous route of the autonomous vehicle is disrupted, a router system of the vehicle can select a different route to reach the same target destination. For example, if the target destination is located behind the blocked-off scene, the router can direct the vehicle on a detour path that bypasses the blocked area and approaches the target destination from a different direction.

Advantages of the disclosed implementations include, but are not limited to, accurate, reliable, and fast identification and navigation of blocked traffic lanes. Multiple heuristics modules and MLMs operating in parallel and processing different sets of input data improve accuracy of BL detection and reduce significantly the number of false positives (open lanes incorrectly identified as blocked) and false negatives (blocked lanes incorrectly identified as open). This leads to improved driving trajectory selection and enhanced safety of driving operations.

In those instances, where description of the implementations refers to autonomous vehicles, it should be understood that similar techniques can be used in various driver-assistance systems that do not rise to the level of fully autonomous driving systems. In some embodiments, disclosed techniques can be used in Level 2 driver-assistance systems that implement steering, braking, acceleration, lane centering, adaptive cruise control, etc., as well as other driver support. In some embodiments, the disclosed techniques can be used in Level 3 driving-assistance systems capable of autonomous driving under limited (e.g., highway) conditions. In such systems, fast and accurate detection and tracking of objects can be used to inform the driver of the approaching vehicles and/or other objects, with the driver making the ultimate driving decisions (e.g., in Level 2 systems), or to make certain driving decisions (e.g., in Level 3 systems), such as reducing speed, changing lanes, etc., without requesting driver's feedback.

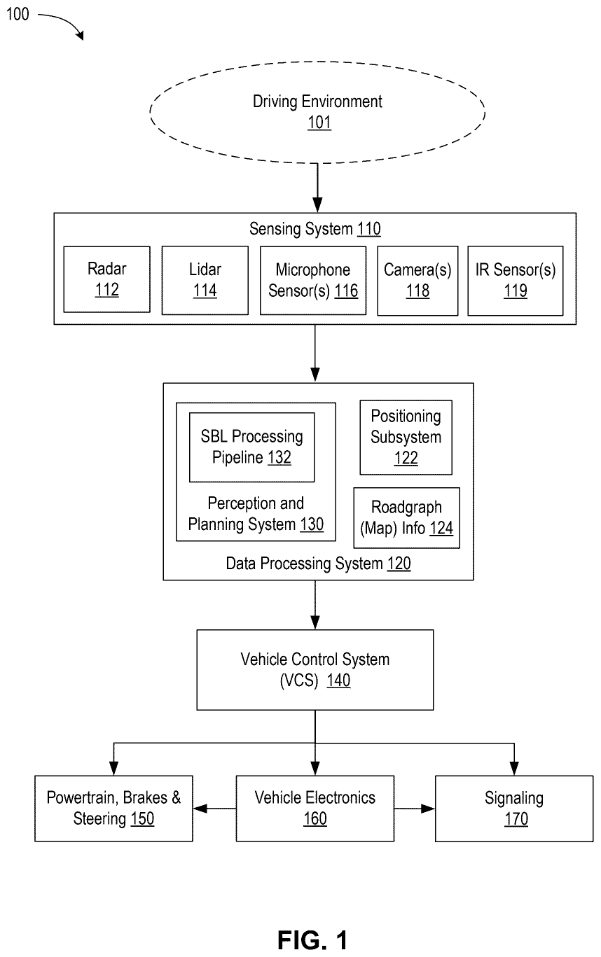

FIG. 1 is a diagram illustrating components of an example vehicle 100 capable of deploying a processing pipeline for detection and navigation of semantically blocked lanes (BLs) in driving environments, in accordance with some implementations of the present disclosure. In some implementations, vehicle 100 can be an autonomous vehicle. Autonomous vehicles can include motor vehicles (cars, trucks, buses, motorcycles, all-terrain vehicles, recreational vehicles, any specialized farming or construction vehicles, and the like), or any other self-propelled vehicles (e.g., robots, factory or warehouse robotic vehicles, sidewalk delivery robotic vehicles, etc.) capable of being operated in a self-driving mode (without a human input or with a reduced human input).

A driving environment 101 can include any objects (animate or inanimate) located outside the vehicle 100, such as roadways, buildings, trees, bushes, sidewalks, bridges, mountains, other vehicles, pedestrians, and so on. The driving environment 101 can be urban, suburban, rural, and so on. In some implementations, the driving environment 101 can be an off-road environment (e.g., farming or other agricultural land). In some implementations, the driving environment can be an indoor environment, e.g., the environment of an industrial plant, a shipping warehouse, a hazardous area of a building, and so on. In some implementations, the driving environment 101 can be substantially flat, with various objects moving parallel to a surface (e.g., parallel to the ground). In other implementations, the driving environment can be three-dimensional and can include objects that are capable of moving along all three directions (e.g., balloons, leaves, etc.). Hereinafter, the term “driving environment” should be understood to include all environments in which an autonomous motion of self-propelled vehicles can occur. For example, “driving environment” can include any possible flying environment of an aircraft or a marine environment of a naval vessel. The objects of the driving environment 101 can be located at any distance from vehicle 100, from close distances of several feet (or less) to several miles (or more).

As described herein, in a semi-autonomous or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods can be described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 (L2) driver-assistance systems that implement steering, braking, acceleration, lane centering, adaptive cruise control, etc., as well as other driver support. The disclosed systems and methods can be used in SAE Level 3 (L3) driving-assistance systems capable of autonomous driving under limited (e.g., highway) conditions. Likewise, the disclosed systems and methods can be used in vehicles that use SAE Level 4 (L4) self-driving systems that operate autonomously under most regular driving situations and require only occasional attention of the human operator. In all such driving-assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

The example vehicle 100 can include a sensing system 110. The sensing system 110 can include various electromagnetic (e.g., optical) and non-electromagnetic (e.g., acoustic) sensing subsystems and/or devices. The sensing system 110 can include a radar (or multiple radars) 112, which can be any system that utilizes radio or microwave frequency signals to sense objects within the driving environment 101 of the vehicle 100. The radar(s) 112 can be configured to sense both the spatial locations of the objects and velocities of the objects (e.g., using the Doppler shift technology). Hereinafter, “velocity” refers to both how fast the object is moving (the speed of the object) as well as the direction of the object's motion. In some implementations, the sensing system 110 can include a lidar 114, which can be a laser-based unit capable of determining distances to the objects (including their spatial dimensions) and velocities of the objects in the driving environment 101. Each of radar 112 and lidar 114 can include a coherent sensor, such as a frequency-modulated continuous-wave (FMCW) lidar or radar sensor. For example, radar 112 can use heterodyne detection for velocity determination. In some implementations, the functionality of a ToF and coherent radar is combined into a radar unit capable of simultaneously determining both the distance to and the radial velocity of the reflecting object. Such a unit can be configured to operate in an incoherent sensing mode (ToF mode) and/or a coherent sensing mode (e.g., a mode that uses heterodyne detection) or both modes at the same time. In some implementations, multiple radars 112 or lidars 114 can be mounted on vehicle 100.

Lidar 114 can include one or more light sources producing and emitting signals and one or more detectors of the signals reflected back from the objects. In some implementations, lidar 114 can perform a 360-degree scanning in a horizontal direction. In some implementations, lidar 114 can be capable of spatial scanning along both the horizontal and vertical directions. In some implementations, the field of view can be up to 90 degrees in the vertical direction (e.g., with at least a part of the region above the horizon being scanned with lidar signals). In some implementations, the field of view can be a full sphere (consisting of two hemispheres).

The sensing system 110 can further include one or more cameras 118 to capture images of the driving environment 101. The images can be two-dimensional projections of the driving environment 101 (or parts of the driving environment 101) onto an imaging surface (flat or non-flat) of the camera(s). Some of the cameras 118 of the sensing system 110 can be video cameras configured to capture a continuous (or quasi-continuous) stream of images of the driving environment 101. The sensing system 110 can also include one or more infrared (IR) sensors 119. The sensing system 110 can further include one or more microphone sensors 116 that can be used to capture audio data for the driving environment, e.g., sirens and other sounds of emergency vehicles.

The sensing data obtained by the sensing system 110 can be processed by a data processing system 120 of vehicle 100. For example, the data processing system 120 can include a perception and planning system 130. The perception and planning system 130 can be configured to detect and track objects in the driving environment 101 and to recognize the detected objects. For example, perception and planning system 130 can analyze images captured by the cameras 118 and can be capable of detecting traffic light signals, road signs, roadway layouts (e.g., boundaries of traffic lanes, topologies of intersections, designations of parking places, and so on), presence of obstacles, and the like. Perception and planning system 130 can further receive radar sensing data (Doppler data and ToF data) and determine distances to various objects in the environment 101 and velocities (radial and, in some implementations, transverse, as described below) of such objects. In some implementations, perception and planning system 130 can use radar data in combination with the data captured by the camera(s) 118, as described in more detail below.

Perception and planning system 130 monitors how the driving environment 101 evolves with time, e.g., by keeping track of the locations and velocities of the animate objects (e.g., relative to Earth and/or the AV) and predicting how various objects are to move in the future, over a certain time horizon, e.g., 1-10 seconds or more. Perception and planning system 130 can include a BL processing pipeline 132 to identify presence of objects that can be blocking at least a portion of driving environment 101, confirm or rule out that the blocking is intended to close off one or more driving lanes, determine which lanes of driving environment 101 are blocked and which lanes are open to traffic, including lanes having a modified pattern (e.g., shifted lanes), and so on. BL processing pipeline 132 can include one or more heuristic modules and one or more trainable MLMs that can process data of multiple modalities, e.g., camera data, radar data, lidar data, audio data, roadgraph data, and/or the like.

Perception and planning system 130 can also receive information from a positioning subsystem 122, which can include a GPS transceiver and/or inertial measurement unit (IMU) (not shown in FIG. 1), configured to obtain information about the position of the AV relative to Earth and its surroundings. Positioning subsystem 122 can use the positioning data, e.g., GPS and IMU data) in conjunction with the sensing data to help accurately determine the location of vehicle 100 with respect to fixed objects of the driving environment 101 (e.g., roadways, lane boundaries, intersections, sidewalks, crosswalks, road signs, curbs, surrounding buildings, etc.) whose locations can be provided by roadgraph information 124. In some implementations, data processing system 120 can receive non-electromagnetic data, such as audio data (e.g., ultrasonic sensor data or data from one or more microphone sensors 116 detecting emergency vehicle sirens), temperature sensor data, humidity sensor data, pressure sensor data, meteorological data (e.g., wind speed and direction, precipitation data), and the like.

The data generated by perception and planning system 130, positional subsystem 122, and/or the other systems and components of data processing system 120 can be used by an autonomous driving system, such as vehicle control system (VCS) 140. The VCS 140 can include one or more algorithms that control how vehicle 100 is to behave in various driving situations and environments. For example, the VCS 140 can include a navigation system for determining a global driving route to a destination point. The VCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The VCS 140 can also include an obstacle avoidance system for safe avoidance of various obstructions (rocks, stalled vehicles, a jaywalking pedestrian, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of VCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions output by the VCS 140 can be delivered directly to the powertrain, brakes, and steering 150 (or signaling 170) whereas other instructions output by the VCS 140 are first delivered to the vehicle electronics 160, which generates commands to the powertrain, brakes, and steering 150 and/or signaling 170.

In one example, the VCS 140 can determine that an obstacle identified by the data processing system 120 is to be avoided by decelerating the vehicle until a safe speed is reached, followed by steering the vehicle around the obstacle. The VCS 140 can output instructions to the powertrain, brakes, and steering 150 (directly or via the vehicle electronics 160) to: (1) reduce, by modifying the throttle settings, a flow of fuel to the engine to decrease the engine rpm; (2) downshift, via an automatic transmission, the drivetrain into a lower gear; (3) engage a brake unit to reduce (while acting in concert with the engine and the transmission) the vehicle's speed until a safe speed is reached; and (4) perform, using a power steering mechanism, a steering maneuver until the obstacle is safely bypassed. Subsequently, the VCS 140 can output instructions to the powertrain, brakes, and steering 150 to resume the previous speed settings of the vehicle.

In the description of figures below, the term “vehicle” is used to indicate an automotive machine deploying the disclosed techniques to identify and navigate BLs. The term “object” is used to indicate any road user that can intentionally or accidentally block the roadway or any portion of it. “Object” can include any type of vehicle, e.g., car, truck, van, SUV, vehicle pulling a trailer, motorcycle, scooter, bicycle, etc., but can also include an officer, an emergency responder, a pedestrian, an animal, and/or the like.

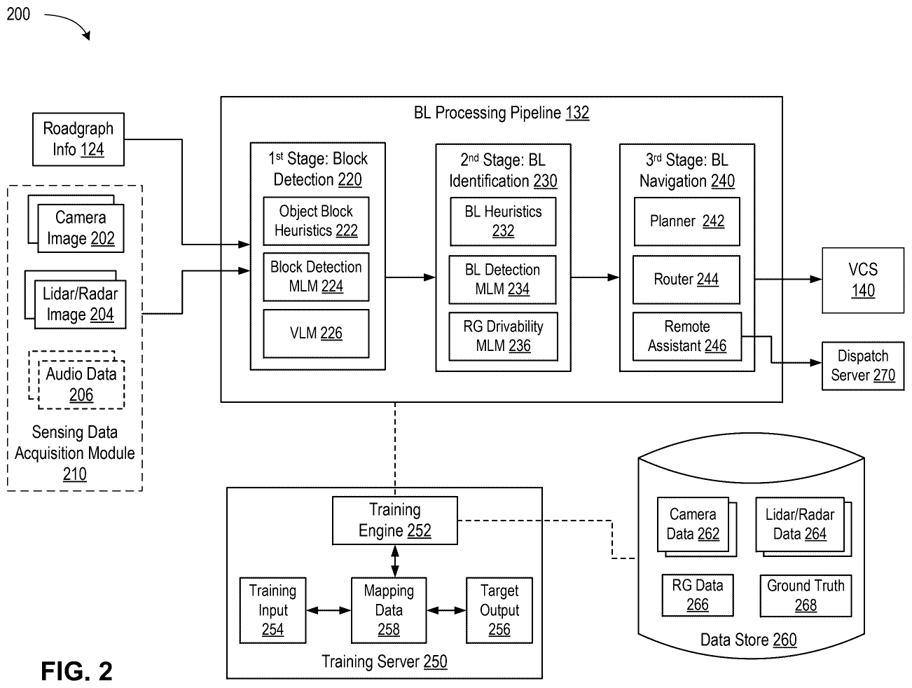

FIG. 2 is a diagram illustrating an example system architecture 200 that can be used for training and deployment of a BL processing pipeline capable of identifying and navigating BLs in driving environments, in accordance with some implementations of the present disclosure. An input into BL processing pipeline 132 can include data obtained by sensing system 110 (e.g., by radar 112, lidar 114, camera(s) 118, and/or other sensors, with reference to FIG. 1). The obtained data can be provided via a sensing data acquisition module 210 that can decode, preprocess (e.g., denoise, up- or downsample, etc.), reformat, crop, etc., sensing data to a format accessible to BL processing pipeline 132. In one example implementation, sensing data acquisition module 210 can obtain a sequence of camera images 202, e.g., two-dimensional projections of the driving environment (or a portion thereof) on an array of sensing detectors (e.g., charged coupled device or CCD detectors, complementary metal-oxide-semiconductor or CMOS detectors, and/or the like). Individual camera images can have pixels of various intensities of one color (for black-and-white images) or multiple colors (for color images). Camera images 202 can be panoramic (360-degree) images or images depicting a specific portion of the driving environment. Camera images 202 can include a number of pixels. The number of pixels can depend on the resolution of the image. Each pixel can be characterized by one or more intensity values. A black-and-white pixel can be characterized by one intensity value, e.g., representing the brightness of the pixel, with value 1 corresponding to a white pixel and value 0 corresponding to a black pixel (or vice versa). The intensity value can assume continuous (or discretized) values between 0 and 1 (or between any other chosen limits, e.g., 0 and 255). Similarly, a color pixel can be represented by more than one intensity value, such as three intensity values (e.g., if the RGB color encoding scheme is used) or four intensity values (e.g., if the CMYK color encoding scheme is used). Camera images 202 can be preprocessed, e.g., downscaled (with multiple pixel intensity values combined into a single pixel value), upsampled, filtered, denoised, and the like. Camera images 202 can be in any suitable digital format (JPEG, TIFF, GIG, BMP, CGM, SVG, and so on).

Sensing data acquisition module 210 can further obtain lidar and/or radar images 204, which can include a set of return points (point cloud) corresponding to lidar (radar) beam reflections from various objects in the driving environment. Each return point can be understood as a data unit (pixel) that includes coordinates of reflecting surfaces, radial velocity data, intensity data, and/or the like. For example, sensing data acquisition module 210 can provide lidar/radar images 204 that include the lidar (and/or radar) intensity map I(R, θ, ϕ), where R, θ, ϕ is a set of spherical coordinates. In some implementations, Cartesian coordinates, elliptic coordinates, parabolic coordinates, or any other suitable coordinates can be used instead. The lidar (radar) intensity map identifies an intensity of the radar (lidar) reflections for various points in the field of view of the radar (lidar). The coordinates of objects that reflect lidar (and/or radar) signals can be determined from directional data (e.g., polar θ and azimuthal ϕ angles in the direction of signal transmissions) and distance data (e.g., radial distance R determined from the time of flight of the signals). Lidar/radar images 204 can further include velocity data of various reflecting objects identified based on detected Doppler shift of the reflected signals.

Camera images 202, lidar/radar images 204 can be large images of the entire driving environment or images of smaller portions of the driving environment (e.g., camera image acquired by a forward-facing camera(s) of the sensing system 110). In some implementations, sensing data acquisition module 210 can crop camera images 202, lidar/radar images 204 corresponding to a certain segment around a direction of motion of the vehicle. For example, since relevant traffic lanes of interest are typically located around the direction of travel of the vehicle, sensing data acquisition module 210 can crop camera images 202, lidar/radar images 204 to within a forward-looking segment that is 200-250 m long and 20-40 m wide, in one example non-limiting implementation. The size of the segment can depend on the speed of the vehicle and a type of the driving environment and can be different for a highway driving environment than for an urban driving environment.

Camera images 202, lidar/radar images 204, roadgraph information 124, and, in some implementations, audio data 206, can be used as an input into BL processing pipeline 132, which can include multiple stages, e.g., a block detection stage 220, a BL identification stage 230, and BL navigation stage 240. Block detection stage 220 can determine whether one or more objects intentionally or accidentally block at least a portion of the roadway. Block detection stage 220 can deploy an object block heuristics module 222 that uses position and orientation of an object on the roadway and various other heuristics (presence of warning signals, emergency personnel, and/or the like) to identify presence (or absence) of a road blockage. Block detection stage 220 can further include a block detection MLM 224 that classifies (predicts) lane-blocking types among one or more defined (in training) categories. Block detection stage 220 can further include a vision language model (VLM) 226 trained to associate visual depictions of objects in camera images 202 with various textual descriptions of blockages (or normal driving situations).

BL identification stage 230 can be used in those situations that have been identified (by the block detection stage 220) to include an object intentionally or accidentally blocking at least a portion of the roadway. In some implementations, BL identification stage 230 can include a BL heuristics module 232 that determines a lane map by identifying lanes as blocked, normal, shifted, and/or the like, e.g., using a location, type, size, and orientation of the object identified as causing the blockage. BL identification stage 230 can further include a BL detection MLM 234 to process roadgraph features and features representing the sensing data to perform end-to-end (E2E) classification of lanes as blocked/normal/shifted/etc. BL identification stage 230 can further include a roadgraph (RG) drivability MLM 236 that processes the sensing data of multiple modalities (e.g., lidar/radar/camera/etc.) and the roadgraph information 124 to generate a heatmap of probabilities indicative of the likelihood that various lanes in the driving environment are blocked. The heatmap of probabilities overlaid over the roadgraph information 124 can be used to generate a lane map independently of the BL heuristics module 232 and/or BL detection MLM 234.

Multiple lane maps generated by the BL identification stage 230 can be aggregated to determine a final map of drivable areas of the roadway that can be used as an input into a third BL navigation stage 240, which can include a planner 242 that charts a short-horizon (e.g., within a portion of the roadway visible to the vehicle's sensing system) path of the vehicle based on the information about open traffic lanes identified by the BL identification stage 230. BL navigation stage 240 can also include a router 244 to determine a longer-horizon path to a specific destination of the vehicle. BL navigation stage 240 can further include a remote assistant component 246 that can be used to validate lane maps generated by the BL identification stage 230. For example, in some implementations, the lane maps can be communicated to a dispatch server 270 (e.g., a server of a fleet of autonomous vehicles) together with some portion of the dynamic sensing data (e.g., one or more camera images 202, lidar/radar images 204) where a human dispatcher can validate or correct the lane drivability determination obtained by the BL processing pipeline 132. Additionally, data communicated by remote assistant 246 to dispatch server 270 can be shared (optionally, after validation by the dispatcher) with other vehicles of the fleet. Similarly, in the instances where a route of the autonomous vehicle is affected by one or more BLs identified by other vehicles of the fleet, the remote assistant 246 of the autonomous vehicle can receive such information from dispatch server 270. Using the received information, router 244 can select a different route for the autonomous vehicle that avoids the identified BLs. Driving paths and routes charted by planner 242 and router 244 can be implemented by VCS 140 of the autonomous vehicle.

Training of various components of BL processing pipeline 132 can be performed by a training engine 252 hosted by a training server 250, which can be an outside server that deploys one or more processing devices, e.g., central processing units (CPUs), graphics processing units (GPUs), parallel processing units (PPUs), and/or the like. Training engine 252 can have access to a data store 260 storing various training data for training of BL processing pipeline 132. In some implementations, training data can include camera images 262 acquired during actual driving missions by onboard cameras and can further include lidar/radar images 264 associated with camera images 262, e.g., radar/lidar images of substantially the same regions of corresponding driving environments acquired at substantially the same time as camera images 262. Training data stored by data store 260 can further include roadgraph data 266 and ground truth 268, which can include correct identification of blocking events and markings of blocked lanes. In some implementations, such ground truth 268 can be determined by a developer manually identifying BLs of the environment. Ground truth 268 can further include driving trajectories selected by a human expert driver during historical driving missions and identified from logs of such driving missions.

BL processing pipeline 132, as illustrated in FIG. 2, can be trained using training data that includes training inputs 254 and corresponding target outputs 256 (correct matches for the respective training inputs). During training, training engine 252 can retrieve training data from data store 260, prepare one or more training inputs 254 and one or more target outputs 256 (based on ground truth 268) and use the prepared inputs and outputs to train one or more trainable models of the BL processing pipeline 132, including but not limited to intent detection MLM 224, VLM 226, BL detection MLM 234, and/or RG drivability ML 236. Training data can also include mapping data 258 that maps training inputs 254 to the target outputs 256. During training of BL processing pipeline 132, training engine 252 can cause various models of the BL processing pipeline 132 to learn patterns in the training data captured by training input/target output pairs. To evaluate differences between training outputs and target outputs 256, training engine 252 can use various suitable loss functions such as a mean squared error loss function (e.g., to evaluate departure from continuous ground truth values, e.g., distances to signs), binary cross-entropy loss function (e.g., to evaluate departures from binary classifications), and/or any other suitable loss function. In some implementations, models of the BL processing pipeline 132 can be trained by training engine 252 and subsequently downloaded onto the perception and planning system 130 of the vehicle.

During training of the models of BL processing pipeline 132, training engine 252 can change parameters (e.g., weights and biases) of the model(s) until the model(s) successfully learn(s) to accurately identify situations of blockages (as opposed to traffic jams or slow traffic) and correctly identify lanes as blocked/normal/shifted/etc., and/or correctly chart vehicle's driving paths that avoid BLs and use open lanes. In some implementations, any model of the BL processing pipeline 132 can be trained in multiple versions for use under different conditions and for different driving environments, e.g., separate models can be trained for street driving and for highway driving. Different trained models can have different architectures (e.g., different numbers of neuron layers and/or different topologies of neural connections), different settings (e.g., types and parameters of activation functions, etc.), and can be trained using different sets of hyperparameters (e.g., number of epochs, learning rate, and/or the like).

The data store 260 can be a persistent storage capable of storing radar images, camera images, as well as data structures configured to facilitate accurate and fast identification and validation of sign detections, in accordance with various implementations of the present disclosure. Data store 260 can be hosted by one or more storage devices, such as main memory, magnetic or optical storage disks, tapes, or hard drives, network-attached storage (NAS), storage area network (SAN), and so forth. Although depicted as separate from training server 250, in some implementations, the data store 260 can be a part of training server 250. In some implementations, data store 260 can be a network-attached file server, while in other implementations, data store 260 can be some other type of persistent storage such as an object-oriented database, a relational database, and so forth, that can be hosted by a server machine or one or more different machines accessible to the training server 250 via a network (not shown in FIG. 2).

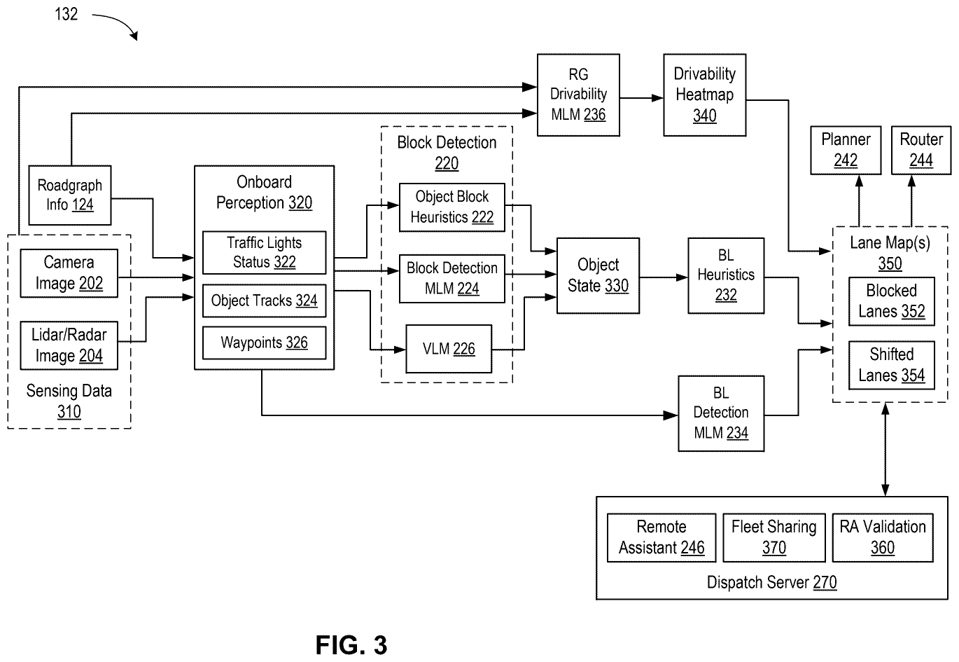

FIG. 3 illustrates a data flow of an example BL processing pipeline 132 capable of efficient identification and navigation of blocked and shifted lanes in driving environments, in accordance with some implementations of the present disclosure. As shown in FIG. 3, BL processing pipeline 132 can use static roadgraph information 124 and dynamic sensing data 310, which can include any, some, or all of camera images 202, lidar/radar images 204, audio data (not explicitly shown in FIG. 3), and/or the like. In some implementations lidar/radar images 204 can include only lidar images. In some implementations lidar/radar images 204 can include only radar images. In some implementations lidar/radar images 204 can include both lidar images and radar images.

Individual camera images 202 (and, similarly, lidar/radar images 204) can be associated with specific times t₁, t₂, t₃, . . . of capture of the respective images. Acquisition of sensing data 310 can be synchronized, so that the images of multiple sensing modalities, e.g., camera images 202 and/or lidar/radar images 204, depict the driving environment at substantially the same times. Sensing data 310 and roadgraph info 124 can be processed by onboard perception system 320 that can include one or more computer vision models trained to identify objects of interest, e.g., vehicles, pedestrians, traffic lights, animals, and/or the like. For example, camera images 202 and/or lidar/radar images 204 can be large images of the entire driving environment or images of a significant portion of the driving environment (e.g., camera image acquired by a forward-facing camera(s) of the vehicle's sensing system). In some implementations, the acquired camera images 202, lidar and/or radar images 204 can be processed by an object detection model (or multiple models) of onboard perception system 320 trained to identify individual objects in the driving environment, including locations (e.g., coordinates) of the objects, orientations (e.g., heading directions) of the objects, sizes (e.g., bounding boxes) of the objects, types (e.g., car, truck, bus, bicyclist, pedestrian, emergency vehicle, etc.) of the objects, status of the objects (e.g., moving, stopped, parked, emergency vehicle with siren/lights on, etc.), and/or the like. Onboard perception system 320 can identify images of traffic lights and determine traffic lights status 322, e.g., one or more signals displayed by the traffic lights in the driving environment, e.g., green signal, yellow signal, red signal, signals indicating allowed turns, turns allowed after yielding to other vehicles, prohibited turns, and/or the like.

Onboard perception system 320 can generate object tracks 324 for various identified objects. Object tracks 324 can be maintained throughout the times when specific objects remain within the driving environment and can be updated with new geo-motion data collected for additional timestamps tⱼ, e.g., coordinates \vec{R}(tⱼ), velocity \vec{V}(tⱼ), acceleration \vec{α}(tⱼ), angular velocity \vec{ω}(tⱼ), etc. In some implementations, tracking and prediction component 134 can deploy a suitable statistical filter, e.g., a Kalman filter. Kalman filter can compute: (i) a most probable geo-motion data in view of the measurements (images) obtained, (ii) predictions made according to a physical model of object's motion, and (ii) statistical assumptions about measurement errors (e.g., covariance matrix of errors). Based on the collected data and maintained object tracks 324, onboard perception system 320 can predict, for a certain time horizon (e.g., one or several second), a likely future motion of various objects. Onboard perception system 320 can further track various waypoints 326 in the driving environment, such as lane locations, intersections, turns, stop lines, pedestrian crossings, lane merges, lane splits, and/or the like. Waypoints 326 can be mapped to roadgraph information 124 to verify accuracy of roadgraph information 124. In those instances where waypoints determined using dynamic sensing data 310 differ from waypoints in roadgraph information 124, onboard perception 320 can presume that the waypoints determined using sensing data 310 are more accurate. Traffic lights status 322, object tracks, 324, and/or waypoints 326 can be used as an input into block detection stage 220. Inputs into any or some of the models of block detection stage 220 can also include at least some of the sensing data 310 (e.g., camera images 202) in addition to the sensing data that underwent processing by onboard perception system 320.

Object block heuristics module 222 of the block detection stage 220 can identify whether one or more objects block at least a portion of the roadway, e.g., a stalled or crashed vehicle, a police vehicle closing one or more lanes near an accident scene, a crime scene, or a hazardous material spill, and/or the like. In some implementations, object block heuristics module 222 can access object tracks 324 to determine position of an object being assessed for blockage, current state of motion (e.g., speed and direction of motion) of the object, and previous positions/states of motion for a certain time horizon or for a total time of observation of the object. In some implementations, object block heuristics module 222 can further access roadgraph information 124, e.g., to determine if there is an intersection in the vicinity of the vehicle's or object's location, with the proximity to the intersection making the object less likely to be blocking traffic as opposed to moving slowly with traffic, standing in a traffic jam, waiting for the intersection to clear before entering, and/or the like. On the other hand, location of the object within the intersection can be indicative of a more likely blocking state, e.g., a disabled vehicle or an emergency vehicle. Information accessed by object block heuristics module 222 can further include a heading of the object, e.g., a difference between the heading of the object and the direction of traffic (including instances of the object located on the wrong side of the road), with larger differences indicative of a more likely blocking state and smaller differences indicative of a more likely normal pattern of motion (e.g., an attempted lane change in a traffic jam). Information accessed by object block heuristics module 222 can further include whether the vehicle or an object are located within the parking area, with the parking area indicative of a less likely blockage.

Information accessed by object block heuristics module 222 can further include object types and attributes, e.g., presence of flashing hazard lights (including lights reflected from buildings and/or other objects) or other active warning signals on or about the object (e.g., a warning triangle), body damage on the object, shards of broken glass near the object, and/or the like. Information accessed by object block heuristics module 222 can further include types and/or attributes of other proximate objects, e.g., one or more emergency vehicles, presence of one or more uniformed officers, warning (orange or red) cones, caution tape, flares, fire hoses, and/or the like.

Object block heuristics module 222 can assign (e.g., empirically set) weights to various information referenced above and/or other similar information to obtain a likelihood (e.g., probability) that the object is blocking traffic (e.g., intentionally or as a result of an accident or some other immobilizing cause). In some implementations, various blocking occurrences can be grouped into multiple scenarios, e.g., a single emergency vehicle (EV) scenario (e.g., a single police car blocking traffic), a multi-EV scenario (e.g., multiple police cars blocking off a scene of a crash, a simultaneous presence of police, ambulance, and/or fire vehicles, etc.), a no-EV scenario (e.g., a scene of a crash prior to arrival of emergency responders, etc.), and/or the like.

In some implementations, independent (parallel) identification of blocking objects can be performed using a block detection MLM 224 processing traffic lights status 322, object tracks 324, waypoints 326, and/or various additional roadgraph information 124, as disclosed below.

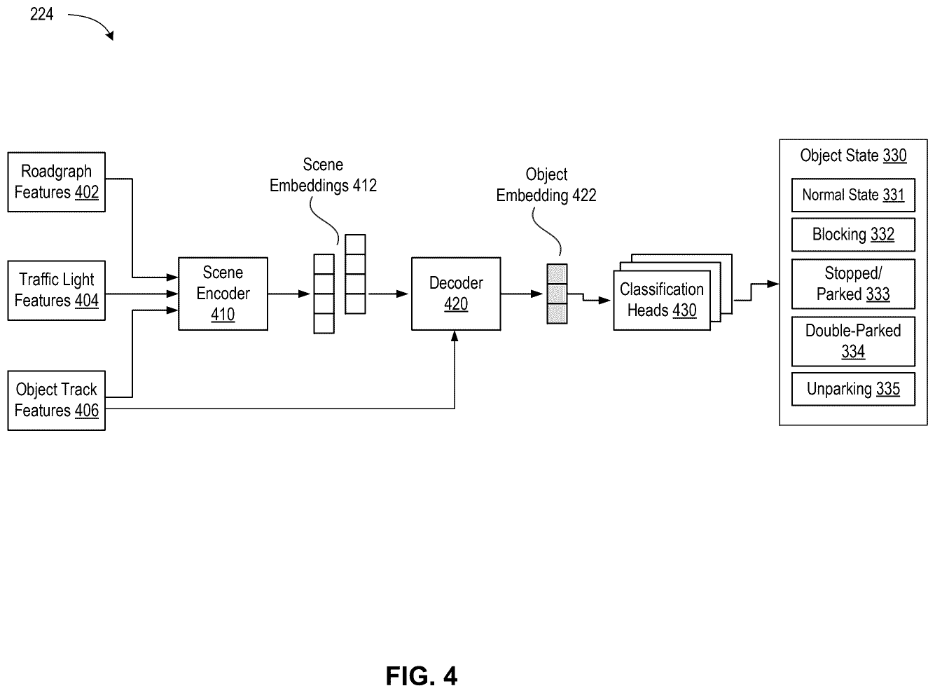

FIG. 4 illustrates an example architecture of a block detection MLM 224 capable of identifying objects as blocking at least a portion of a driving environment, in accordance with some implementations of the present disclosure. Various input information processed by block detection MLM 224 can be represented via features (embeddings) that embed respective inputs into digital data. For example, roadgraph information can be embedded in roadgraph features 402, traffic lights status can be embedded in traffic light features 404, object tracks can be embedded in object track features 406, and so on. A feature vector (an embedding) should be understood as any suitable digital representation of an input data, e.g., as a vector (string) of any number M of components, which can have integer values or floating-point values. Feature vectors can be considered as points in an M-dimensional embedding space. The dimensionality M of the embedding space (which can be defined as part of any pertinent model architecture) can be smaller than the size of the input data (camera/radar/lidar images). During training, a model learns to associate similar sets of training input data with similar feature vectors represented by points closely situated in the embedding space and further learns to associate dissimilar sets of training input data with points that are located farther apart in that space. Various input features 402-406 can be generated by processing the respective input information via a suitable respective neural embedding network, e.g., a lightweight network having a low number (e.g., two, three, etc.) of fully-connected layers or some other neural layers. Dimensions of roadgraph features 402, traffic light features 404, and/or object track features 406 need not be the same.

In some implementations, roadgraph features 402 can encode various waypoints and lane segments (e.g., via polylines) of a visible portion of the driving environment. Traffic light features 404 can encode the status of traffic lights in the visible portion of the driving environment together with the identification of lanes controlled by various traffic lights. Object track features 406 can encode trajectories of various objects in the visible portion of the driving environment, e.g., coordinates and velocities {\vec{R}(tⱼ), \vec{V}(tⱼ)} of the objects for a set of multiple times tⱼ=t₁ . . . t_{N} associated with a history of motion of the objects, e.g., over the last several seconds preceding the present moment of time.

Block detection MLM 224 may include a scene encoder 410 and a decoder 420. Scene encoder 410 can process input features 402-406 to generate scene embeddings (intermediate embeddings or tokens) 412 that represent various objects, lanes, waypoints, and the like of the visible portion of the driving environment as vectors in a corresponding embedding space (whose number of dimensions can be different from dimension of input features 402-406). Being generated by scene encoder 410, scene embeddings 412 of individual entities (objects/lanes/waypoints/etc.) encode these corresponding entities while also capturing the context of various other entities of the same scene. In some implementations, scene encoder 410 can include a recurrent neural network, a long-short term memory (LSTM) neural network, a fully-connected network, and/or some combination of such networks. In some implementations, scene encoder 410 can have a transformer-based architecture with one or more self-attention blocks.

Decoder 420 can then process scene embeddings 412 generated by scene encoder 410. Additional input into decoder 420 can include object track features 406. In some implementations, decoder 420 can also have a transformer architecture including one or more cross-attention blocks (e.g., in addition to self-attention blocks). For example, object track features 406 can be used as queries by decoder 420 which computes attention scores for a particular object with various entities in the driving environment represented by scene embeddings 412, including objects (other objects and/or the same object), lanes, waypoints, and/or the like. Decoder 420 can output object embeddings 422 for each tracked object identified by the corresponding input object track features 406.

Object embeddings 422 can feed into a number of classification heads 430 that classify various objects in the driving environment among a number of object states 330, including but not limited to a normal state 331 (e.g., an object moving normally, with the flow of traffic), a blocking state 332 (e.g., an object that intentionally, such as police vehicle, or accidentally, such as a crashed/stalled vehicle, blocking at least a portion of the roadway), a stopped/parked state 333 (e.g., an object stopped or parked near a side of the road), a double-parked state 334 (e.g., an object stopped or parked next to a normally parked car and obstructing traffic), an unparking state 335 (e.g., an object beginning motion from a parked/stopped position), and/or any other number of object states 330, as can be defined during training of block detection MLM 224. In some implementations, individual classification heads 430 can output probabilities (e.g., floating-point values) that a particular object is associated with one (or more) blocking states. In some implementations, the final output of the block detection MLM 224 can be a class with the highest probability.

Referring again to FIG. 3, in some implementations, an additional identification of blocking objects can be performed using a vision language model (VLM) 226 trained to process camera images, as disclosed below.

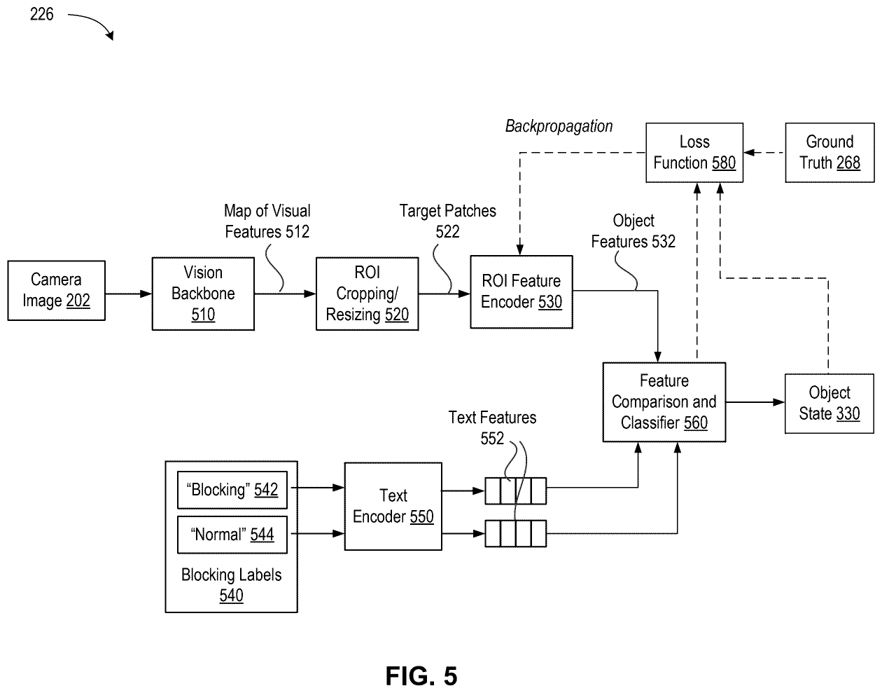

FIG. 5 illustrates an example architecture of a VLM 226 capable of identifying objects as blocking at least a portion of a driving environment using visual images of a driving environment, in accordance with some implementations of the present disclosure. An input into VLM 226 can include camera image(s) 202 of the driving environment, e.g., one or a series of images taken by one or multiple cameras of a vehicle and/or taken at different times. Camera image(s) 202 can be processed by a vision backbone 510 to generate a map of visual features 512 of camera image 202.

In one example, vision backbone 510 can include a deep convolutional neural network. A convolutional network can include any number of filters (kernels) that broaden the perception field and identify features of camera image(s) 202 by aggregating relevant information captured by individual units (pixels) of the image(s) and encoding this information via features arranged in feature maps. Such feature maps can be produced using a sequence of convolution layers and pooling (e.g., average pooling or maximum pooling) layers. A convolution layer applies (usually multiple, e.g., tens, hundreds, or more) filters-limited-size matrices with learned weights—that scan across camera image 202 looking for certain features in the images. Different kernels can look for different features, e.g., boundaries of traffic lanes, outlines of vehicles, and/or the like. Kernels can be moved across images in steps (strides) that are smaller than the dimensions of kernels (e.g., a 5×5 pixel kernel can be shifted by 1, 2, 3 pixels during each step), forming a signal for neural activation functions. A subsampling (pooling) operation then reduces the dimension of the generated feature maps in accordance with a basic premise of the convolution neural network architecture that information about the presence of a target feature is often more important than accurate knowledge of the feature's coordinates. As a result of such multi-layer convolutional-and-pooling processing, intermediate representations of the image can grow along the feature (channel) dimension but shrink along the width-height dimension of the image. This reduction speeds up subsequent computations while simultaneously ensuring the network's capability to process input images of different scales.

Map of visual features 512 can be used to identify presence, in camera image(s) 202, of one or more objects. Regions of interest (ROIs) in camera image(s) 202 can be cropped (while maintaining the number of channel dimensions) to identify target patches 522 of interest and then resized by an ROI cropping/resizing module 520 to match dimensions of an input layer of an ROI feature encoder 530. ROI feature encoder 530 processes target patches 522 and generates object features 532 for objects associated with target patches 522. Object features 532 encode both the visual appearance of individual objects in camera image(s) 202 and a broader context of the whole camera image(s) 202 (including relative positions of other depicted objects).

A feature comparison and classifier 560 can perform comparison of individual object features 532 to a set of text features 552 encoding textual representations of various blocking labels 540 associated with various defined blocking states. For example, blocking labels 540 can include, as shown, a “blocking” label 542 associated with objects that block traffic (intentionally or as a result of an accident or malfunction) and “a normal” label 544 associated with regular (possibly, slow) traffic. Although, for brevity, only two blocking labels 540 are shown in FIG. 5, any additional labels can be defined, e.g., “parked,” “double-parked,” “crashed,” and/or the like. Blocking labels 540 can be embedded, using a suitable text encoder 550, in the same embedding space (e.g., with the same number of dimensions) as used for embedding of object features 532. Text encoder 550 can be any suitable (e.g., lightweight) neural network model trained to generate dissimilar (well-separated in the embedding space) text features for dissimilar blocking labels 540.

Feature comparison and classifier 560 can compare each object feature 532 (\vec{O}) to various text features 552 [symbol] , e.g., by computing the dot product similarity scores,

$${S}_{k} = \frac{\vec{O} \cdot \vec{{T}_{k}}}{\vert \vec{O} \vert \vert \vec{{T}_{k}} \vert} ,$$

or any other similarity measure indicative of a similarity between the object feature 532 and text features 552, e.g., a distance (e.g., Euclidean distance) between the points in the embedding space associated with vectors \vec{O} and [symbol] . The blocking label 540 associated with the highest similarity score Sₖ can be selected as the object state 330 for the corresponding object.

In some implementations, vision backbone 510 and text encoder 550 can be pre-trained, with unchanged or frozen parameters, e.g., weights and biases. Parameters of ROI feature encoder 530 can be modified in training, where ROI feature encoder 530 learns to associate various cues in camera images 202 (e.g., presence of emergency vehicles, personnel, flashing lights, police tape, cones, flares, and/or other indicators of BLs) with correct blocking states of various objects. During training, outputs of ROI feature encoder 530 and/or final object state 330 classifications can be compared with ground truth 268, which can include correct, e.g., human-identified, classifications of blocking states of objects. Comparison can be performed using a suitable loss function 580 and the difference (mismatch) between object states 330 identified by VLM 226 and ground truth 268 can be backpropagated through various neuron layers of ROI encoder 530, e.g., using the steepest descent techniques and/or similar training algorithms. In some implementations, both ROI feature encoder 530 and vision backbone 510 (and/or text encoder 550) can be modified during training.

Referring again to FIG. 3, when one or more of the object block heuristics module 222, block detection MLM 224, and/or VLM 226 determine that one or more objects in the driving environment are associated with a traffic obstruction, e.g., have an object state 330 of “emergency vehicle,” “crash,” “disabled,” “double-parked,” and/or the like, BL heuristics module 232 can determine a lane map 350 identifying normal lanes, blocked lanes 352, shifted lanes 354, and/or the like. Blocked lanes 352 can include mapped (in roadgraph information 124) lanes that are currently undrivable. Shifted lanes 354 can include lanes that are made temporarily by fusing portions of different lanes, by repurposing surfaces previously not allocated to traffic (e.g., shoulders, bus lanes, sidewalks, etc.), and/or using the similar decisions made by emergency responders, road authorities, and/or the like.

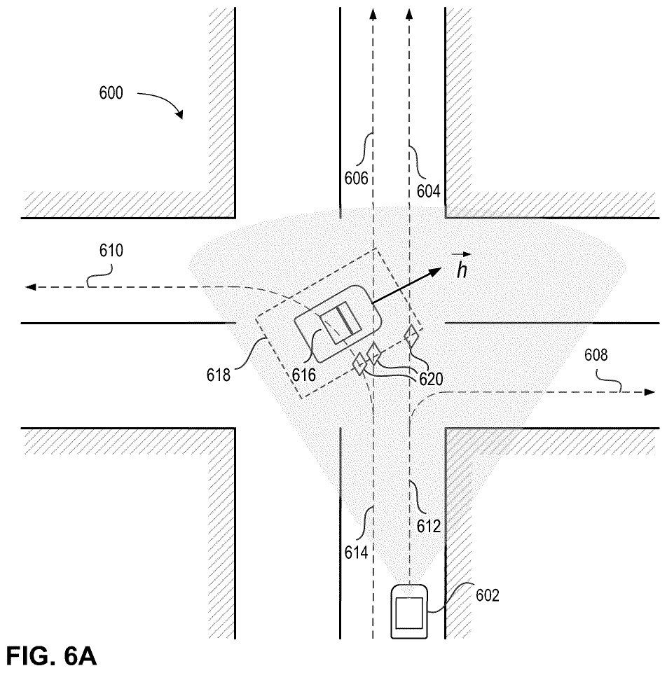

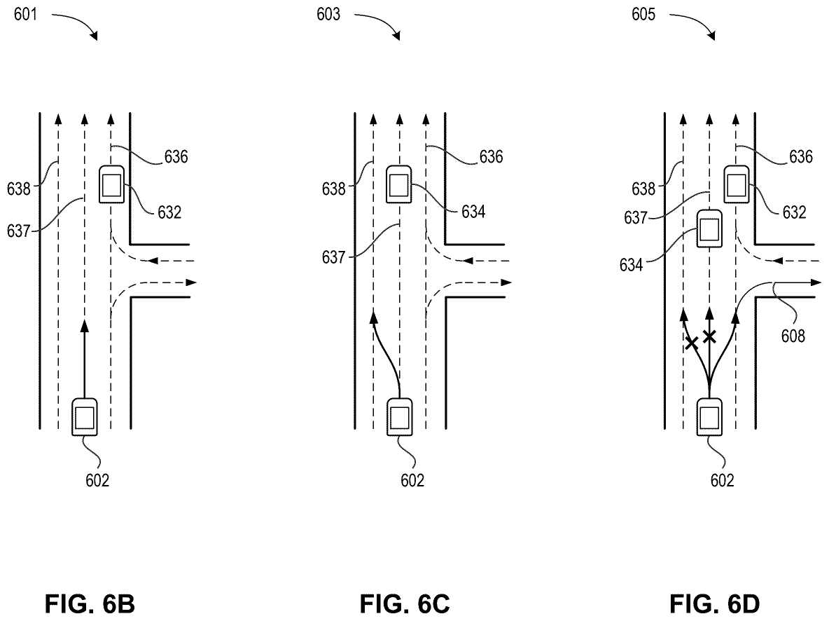

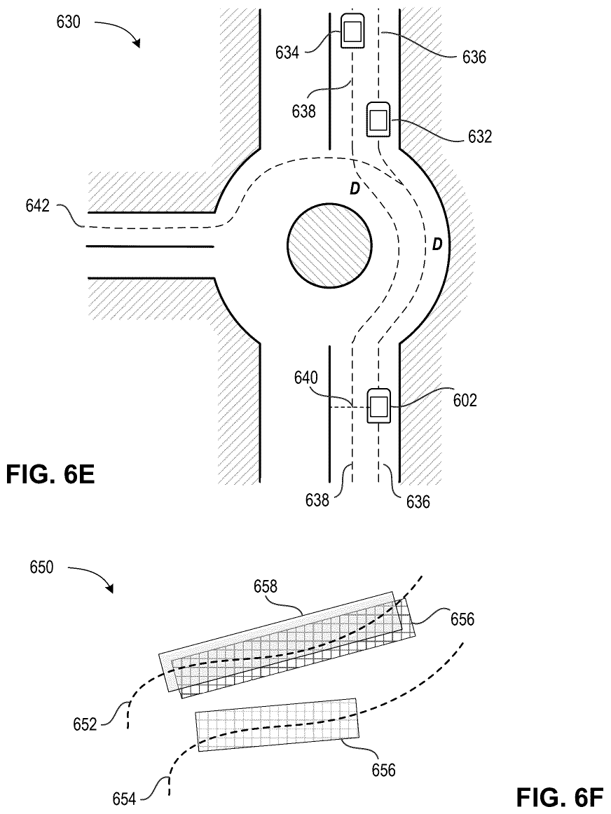

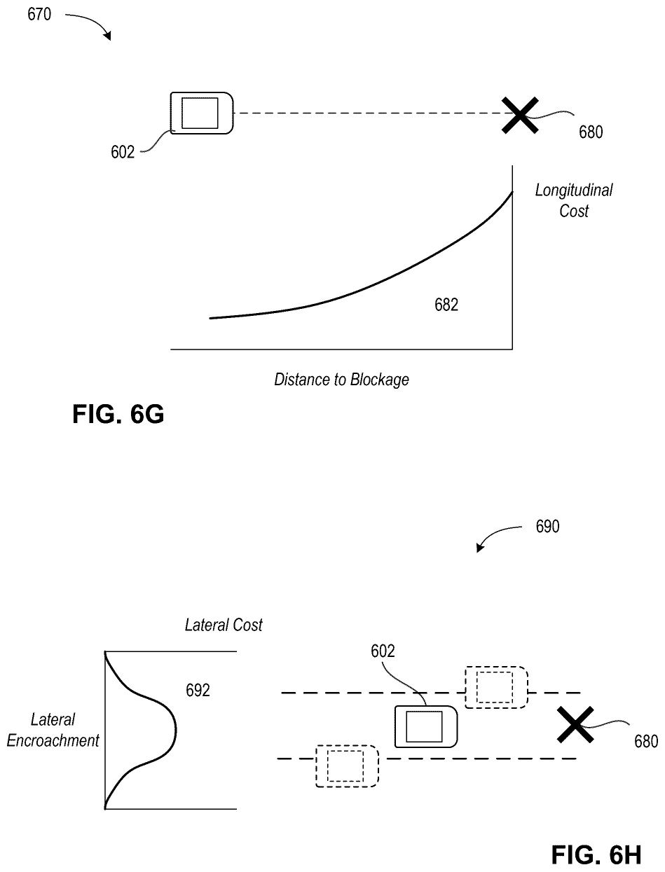

For example, in a single-EV scenario (a situation where block detection stage 220 identifies the presence of one EV in the visible portion of the driving environment), the location, and the heading of the EV can be determined. FIG. 6A illustrates schematically identification of blocked lanes in an example driving environment of an intersection 600, in accordance with some implementations of the present disclosure. FIG. 6A depicts a vehicle 602, e.g., an autonomous vehicle deploying BL processing pipeline 132 for BL identification and navigation. Approaching intersection 600, vehicle 602 can use a static roadgraph information to identify lanes 604-610 that are expected to be accessible to the vehicle 602, e.g., lanes 604 and 606 that go straight through intersection 600, lane 608 that makes the right turn and lane 610 that make the left turn (for ease of viewing, the lanes are indicated with dashed lines corresponding to the medians of the lanes rather than with lane boundaries). Some lanes can have common portions, e.g., lanes 604 and 608 originate from (split off) the right lane 612 approaching the intersection and lanes 606 and 610 originate from the left lane 614 approaching the intersection. Using sensing data (e.g., camera data, lidar data, radar data, audio data, and/or the like), the perception system of vehicle 602 can detect presence of an object 616 within intersection 600 and determine that the heading direction h of object 616 makes an angle that is above a set threshold angle with the lanes within intersection 600. The perception system can further determine that object 616 is stationary and has not been moving for a period of observation by the perception system of vehicle 602 (e.g., the last 5 seconds). In some instances, the perception system can also identify the presence of a uniformed officer in the vicinity of object 616, flashing police lights, and/or other attributes. Based on the above and/or other similar information, object block heuristics module 222 (and/or other components of block detection stage 220 of FIG. 3) can determine that the probability that object 616 is purposefully blocking intersection 600 (e.g., that object 616 is an EV vehicle, e.g., police vehicle deployed to control traffic at the intersection) is above a threshold probability indicative of object state 330 being “blocking” and/or the like.

BL heuristics module 232 can define a bounding box 618 around object 616. Dimensions of bounding box 618 can be of a certain percentage of the dimensions of object 616, e.g., 150% of those dimensions or some other empirically set number. The use of such enlarged bounding boxes emulates human thinking that a lane can be blocked even when not physically occupied, when an EV is positioned in an adjacent lane.

BL heuristics module 232 can position bounding box 618 relative to intersection 600 based on static roadgraph information, dynamic sensing data imaging intersection 600, and/or some combination (e.g., overlap) thereof. BL heuristics module 232 can then identify lane waypoints corresponding to intersections 620 of lanes 604, 606, and 610 with the bounding box 618. Based on the presence of intersections 620 traffic lanes with the bounding box 618, BL heuristics module 232 can classify lanes 604, 606, and 610 as blocked lanes 352 (with reference to FIG. 3) that are not traversable to vehicle 602. Lane 608 that does not intersect with the bounding box 618 can be classified as a normal traversable lane.

In situations of a multi-EV scenario, e.g., where block detection stage 220 identifies presence of two or more EVs in the visible portion of the driving environment, some of the above criteria can be relaxed. For example, object state 330 for individual EVs can be determined as “blocking” even when the corresponding EVs have heading directions that are aligned with the normal traffic directions for the lanes where the EVs are located. In a multi-EV scenario, bounding box 618 can be replaced with a geometric construction that involves placing individual bounding boxes around each EV and then drawing a polygon circumscribing individual bounding boxes. In some implementations, a bounding box for a given EV is included in the polygon provided that the distance from that EV to other EVs is less than a certain empirically set distance; otherwise, the given EV is determined to not belong to the same cluster as other EVs. Similarly, multiple separate clusters of EVs can be defined, each cluster associated with its individual bounding polygon.

In some implementations, BL heuristics module 232 can determine whether the vehicle is to proceed according to a planned trajectory or to select a new trajectory. FIG. 6B illustrates schematically navigating a situation 601 with a blocked lane in the direction of travel of a vehicle, in accordance with some implementations of the present disclosure. More specifically, BL heuristics module 232 of vehicle 602 approaching an intersection in lane 637 can detect that a lane 636 (or more than one lane) of travel in the same direction is blocked after the intersection, e.g., by object 632. BL heuristics module 232 can determine that the lane of travel 637 of vehicle 602 is not blocked and cause vehicle 602 to proceed through the intersection.

FIG. 6C illustrates schematically navigating a situation 603 with a blocked lane of travel of a vehicle, in accordance with some implementations of the present disclosure. More specifically, BL heuristics module 232 of vehicle 602 approaching an intersection in lane 637 can detect that this lane 637 is blocked after the intersection, e.g., by object 634. BL heuristics module 232 can identify that lanes 636 and 638, which travel in the same direction as blocked lane 637, are not blocked and can, therefore, cause vehicle 602 to proceed through the intersection, e.g., after changing the lane of travel from lane 637 to lane 638.

FIG. 6D illustrates schematically navigating a situation 605 with multiple blocked lanes in the direction of travel of a vehicle, in accordance with some implementations of the present disclosure. More specifically, BL heuristics module 232 of vehicle 602 approaching an intersection in lane 637 can detect that this lane 637 is blocked after the intersection, e.g., by object 634 and can further detect that another lane, e.g., lane 636, is blocked after the intersection, e.g., by object 632. (The blockages can occur in a staggered pattern, as illustrated.) BL heuristics module 232 can identify that lane 638, which travels in the same direction as blocked lanes 636 and 637, is not blocked. Nonetheless, since multiple lanes in the direction of travel of vehicle 602 are blocked, BL heuristics module 232 can cause vehicle 602 to reroute using a right-turn lane 608 to avoid proceeding through the intersection where a likely blockage may have occurred (or may be developing).

FIG. 6E illustrates schematically identification of blocked lanes in a situation of objects stopped in a staggered pattern, in accordance with some implementations of the present disclosure. In some situations, e.g., as illustrated for a roundabout intersection 630 in FIG. 6E, an accident can cause objects, e.g., objects 632 and 634, to stop in a staggered pattern. Using collected dynamic sensing data, the perception system of vehicle 602 can detect that object 632 is blocking lane 636, in which vehicle 602 is traveling (like in FIG. 6A, dashed lines indicate medians of lanes rather than lane boundaries), but that lane 638 remains unblocked for some distance between objects 632 and 634. Rather than changing lanes from lane 636 to lane 638 and moving past stopped object 632, vehicle 602 can deploy BL heuristics module 232 to evaluate whether stoppage of objects 632 and 634 is caused by the same blockage (e.g., accident and/or presence of an EV). More specifically, BL heuristics module 232 can compute distance D from vehicle 602 to object 632 along the lane of the vehicle's motion and further identify a waypoint along lane 638 located at distance D from a waypoint 640 that is adjacent to the current location of vehicle 602. If stopped object 634 is located at the same (or approximately the same, within a set tolerance of 10%, 15%, etc.) distance D from waypoint 640 as the distance from vehicle 602 to object 632, both objects 632 and 634 can be determined to be likely associated with the same blockage. Correspondingly, instead of stopping within lane 636 before or on the intersection 630 or changing lanes from lane 636 to lane 638 (and getting stuck in lane 638 after the intersection 630), vehicle 602 can select a different lane, e.g., lane 642 that leaves the roundabout intersection 630 in a different (and unobstructed) direction.

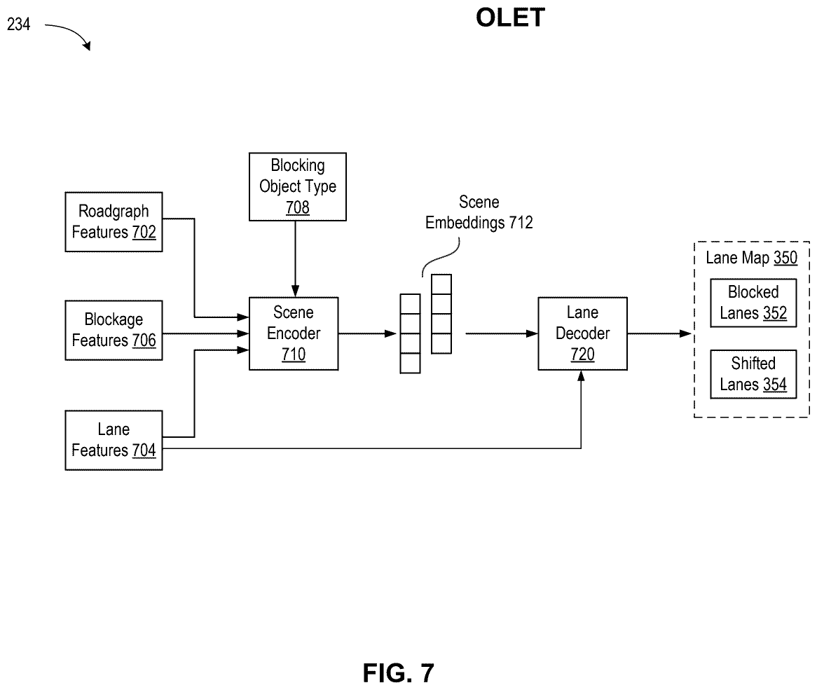

Referring again to FIG. 3, identification of a lane map 350 stage can further include a BL detection MLM 234 and a roadgraph drivability MLM 236. BL detection MLM 234 can perform end-to-end (E2E) processing of sensing data 310 and roadgraph information 124 at the scene level rather than at the individual object level. FIG. 7 illustrates an example architecture of a BL detection MLM 234 capable of end-to-end (EE) identification of blocked and traversable lanes in driving environments, in accordance with some implementations of the present disclosure. In some implementations, BL detection MLM 234 can be a transformer-based model that includes a scene encoder 710 and a lane decoder 720, each having one or more self-attention and/or cross-attention blocks. An input into scene encoder 710 can include features (generated by suitable tokenizer models) representative of the scene, e.g., roadgraph features 702 representative of the static map of the driving scene (which can be similar to roadgraph features 402 used as input into block detection MLM 224 of FIG. 4), lane features 704 representative of individual lanes, and/or blockage features 706 indicative of a presence of blocking accessories in the scene (e.g., cones, tapes, barriers, and/or the like). In some implementations, the input into scene encoder 710 can further include features representative of a blocking object types 708, e.g., presence of sirens, flashing EV lights, and/or the like.

Scene encoder 710 can process any, some, or all input features 702-708 to generate scene embeddings (tokens) 712 in a suitable embedding space. In some implementations, lane features 704 can be used as queries by scene encoder 710 that computes self-attention scores capturing correlations between specific lanes and various other lanes, and further captures correlations between lanes and other inputs of scene encoder 710, e.g., represented by roadgraph features 702, blockage features 706, blocking object types 708, and/or the like.

Scene embeddings 712, which encode various recomputed features of the scene, can be processed by lane decoder 720. In some implementations, lane features 704 can also be used as queries into attention blocks of lane decoder 420. Lane decoder 420 can output lane map 350 classifying various lanes of the scene as blocked lanes 352, shifted lanes 354, normal lanes (not shown in FIG. 7 explicitly). Lane map 350 can be similar but independent from lane map 350 identified by the BL heuristics module 232, with reference to FIG. 3.

An additional lane map 350 can be generated using roadgraph drivability MLM 236 capable of processing sensing data of multiple modalities (e.g., lidar/radar/camera/etc.) together with the static roadgraph information and outputting a heatmap of probabilities P(x, y) indicative of the likelihood that various points x, y of the driving environment are blocked. More specifically, various streams of data—e.g., camera data, lidar data, radar data, etc.—can first be processed by a respective modality network, e.g., a camera network, a lidar network, and/or a radar network, to generate a corresponding set of camera, lidar, and/or features (feature vectors, embeddings), each feature associated with specific locations x, y of the driving environment. Multiple sensing modalities can provide complementary benefits, e.g., with camera images having rich contextual information and capturing both short-range and long-range scenery, lidar data providing high-resolution imaging that is most effective at short-to-medium ranges, and with radar data having lower resolution but being more robust against poor weather conditions and reaching out to long distances.

In some implementations, the camera features, the radar features, and the lidar features can then be combined (concatenated or otherwise aggregated) into a joint feature tensor that can be processed by a backbone network. The backbone model of the roadgraph drivability MLM 236 can also capture temporal context of the sensing data, e.g., by concurrently processing a stack of joint feature tensors corresponding to multiple times (sensing frames). In some implementations, intermediate outputs of the backbone network can be processed by one or more classification heads outputting a drivability heatmap 340 that includes probabilities for various locations x, y of the driving environment to belong to regular lanes that remain accessible, shifted lanes (accessible temporary lanes made of portions of regular lanes), blocked lanes (regular lanes that are currently inaccessible), and/or the like. Drivability heatmap 340 overlaid on the roadgraph can be used to generate discrete classifications for various locations of the driving environment. For example, if a heatmap probability P_{BLOCKED}(x, y) exceeds an empirically set threshold probability P₀ (e.g., P₀=50%, in one example implementation) the location is then determined to be drivable (traversable). Lane map 350 can then be obtained using the drivability heatmap 340 by obtaining (joining) clusters of drivable locations and determining whether a given lane includes locations classified as blocked locations. If the vehicle cannot traverse a lane without driving over one or more blocked locations, such a lane can be classified as blocked lane 352.

Lane maps 350 outputted by one or more of BL heuristics module 232, BL detection MLM 234, and/or roadgraph drivability MLM 236 can be aggregated to determine a final map of drivable lanes of the roadway. In some implementations, a lane is classified as blocked if at least one of BL heuristics module 232, BL detection MLM 234, and/or roadgraph drivability MLM 236 determine that the lane is blocked. FIG. 6F illustrates schematically an identification 650 of blocked lanes using multiple BL detection techniques, in accordance with some implementations of the present disclosure. One (or more) of BL heuristics module 232, BL detection MLM 234, or roadgraph drivability MLM 236 can determine that both lanes 652 and 654 are blocked (e.g., as indicated schematically with patterned shadings 656). Another one (or more) of BL heuristics module 232, BL detection MLM 234, or roadgraph drivability MLM 236 can determine that lane 652 is blocked (e.g., as indicated schematically with uniform shading 658). In some implementations, the aggregated final map of drivable lanes can classify both lanes 652 and 654 as not traversable. In some implementations, the final map of drivable lanes can mark only lane 652 as not traversable.

Referring again to FIG. 3, the aggregated lane map can be used by planner 242 to direct the vehicle to the open (traversable) lanes. If lanes are shifted, planner 242 can identify entry and exit waypoints of the shifted lanes and select, for the vehicle, a trajectory between one of the entry waypoints and one of the exit waypoints and cause the vehicle control system to direct the vehicle to follow the identified trajectory.

Various planner strategies can be used to navigate BLs. In some implementations, the vehicle can be stopped at a certain distance from a blockage (e.g., location of EV or a crashed vehicle), which can be set empirically at 20-50 m, to leave sufficient space for various driving maneuvers, e.g., a multi-point turn in the instances of EV presence of EVs and/or an activity near the accident scene.

In some implementations, the vehicle can creep forward at a small speed (e.g., 0.5-2 mph) to ensure more time for BL detection and/or exchanging data with dispatch server 270, as described in more detail below. In some implementations, the vehicle may abstain from picking up and dropping off passengers near active incident scenes.

If no lanes are available in the direction of the vehicle's travel, planner 242 can direct the vehicle to one of the lanes that remain open, e.g., by taking a right turn, left turn, U-turn, etc. If no lanes remain open, planner 242 can direct the vehicle control system to perform a multi-point turn, and/or a similar maneuver and reverse the direction of motion. In various such instances where a current route of the vehicle is severely disrupted, e.g., requiring taking the vehicle outside a certain vicinity (e.g., an immediately observable region) of the current route, router 244 can select a different route for the vehicle to reach the target destination.

Planner 242 may verify, for various lanes of a portion of the driving environment (e.g., a 150 m portion), if there is a traversable segment in those lanes. Traversable segments can be stored as part of roadgraph information 124. Traversable segments can be stored together with lane context information (referred to as simply lane context herein) for the respective lanes. Lane contexts provide planner 242 with a mechanism to make best choices in optimal lane selection. In particular, the lane contexts can be used to define a cost function (or, simply, a cost herein) that planner 242 associates with driving the vehicle in the respective lane, including a BL. For example, if there is an object stopped within the lane and the lane is identified as a BL, the cost incentivizes the vehicle to move over to a different lane.

In some implementations, the cost can include a longitudinal cost and a lateral cost. FIG. 6G is a schematic illustration 670 of a longitudinal cost that can be used by a planner of a BL processing pipeline for BL navigation, in accordance with some implementations of the present disclosure. FIG. 6G depicts vehicle 602 traveling in a lane that has a blockage 680, e.g., an EV, a crashed or disabled vehicle, police tape, barrier, and/or the like. As illustrated with a schematic plot 682, the longitudinal cost can be an increasing (e.g., linear, power-law, exponential, etc.) function of the distance traveled along the blocked lane (and a decreasing function of the remaining distance to the blockage 680) having a maximum at the blockage 680.

FIG. 6H is a schematic illustration 690 of a lateral cost that can be used by a planner of a BL processing pipeline for BL navigation, in accordance with some implementations of the present disclosure. The lateral cost can depend on a position relative to the center of a blocked lane. (Unlike other figures of the instant disclosure, the dashed lines in FIG. 6H depict lane boundaries). As illustrated with a schematic plot 692, the lateral cost can have a maximum when vehicle 602 is traveling near the center of the blocked lane (maximum encroachment of the blocked lane) and decrease when vehicle 602 moves away from the center of the blocked lane. The lateral cost can be set to zero when vehicle 602 no longer straddles the boundary of the blocked lane (the vehicle is fully within a neighboring lane).

Referring again to FIG. 3, various costs (e.g., longitudinal cost, lateral cost, and/or the like) of staying in a blocked lane can be dependent on a confidence with which blocked lanes 352 are determined. The confidence can include a number of individual determinations (e.g., made using BL heuristics 232, BL detection MLM 234, drivability heatmap 340, and/or the like) agreeing that a given lane is blocked. The confidence can further include a confidence of individual determinations in the blocked lanes. For example, confidence of the determinations made by drivability heatmap 340 can depend on the probabilities that various locations of the roadway are blocked (e.g., with higher confidence given to 80-90% probability of blocked lanes than to 50-60% probabilities). Similarly, probabilities outputted by BL detection MLM 234 (or some measures of those probabilities) can be used for confidence of determinations made using BL detection MLM 234. Similarly, confidence of BL heuristics 232 determination can depend on whether blocked lanes cross a blocking object bounding box near the middle of the bounding box (higher confidence) than near an edge of the bounding box (lower confidence).

In some implementations, lane maps 350 identified by the onboard BL processing 132 pipeline can be communicated to remote assistant (RA) 246 of dispatch server 270 of a fleet of autonomous vehicles for RA validation 360. For example, a dispatcher can validate or correct the lane drivability determination made by the BL processing pipeline 132. In some implementations, data communicated to dispatch server 270 can be used for fleet sharing 370 (in some implementations, after validation by the dispatcher) with other vehicles of the fleet. Similarly, in the instances where a route of the autonomous vehicle is affected by one or more BLs identified by other vehicles of the fleet, RA 246 of dispatch server 270 can communicate this information to the vehicle. The received information can be used by router 244 to select a different route for the vehicle that avoids the BLs identified in the communication from RA 246. In those instances where substantial help from dispatch server 270 is needed, the vehicle can pull over or park at the side of the roadway (to not impede or interfere with other road users) until router 244 and/or dispatch server 270 recomputes the updated route. Driving paths and routes charted by planner 242 and/or router 244 can be implemented by VCS 140 of the autonomous vehicle (with reference to FIG. 2). In some implementations, the vehicle can be pulled over to the side of the roadway if no alternative route is available or if the alternative route is not identified within an empirically preset time limit.

In some implementations, rerouting of the vehicle (e.g., by router 244) can be conditional on a determined severity of a blockage. For example, BL heuristics module 232 and/or BL detection MLM 234 can determine various metrics associated with how severe a blockage can be, e.g., a number of emergency responders and/or EVs present, a number of vehicles with body damage, recency of arrival of emergency responder(s), and/or other similar metrics, which can be weighted to obtain a severity score. If the severity score is above a certain empirically set threshold, router 244 can reroute the driving path of the vehicle. If the severity score is below the threshold, planner 242 can instead cause the vehicle to stop before the blocked lanes (e.g., a certain distance, which can depend on specifics of the driving environment, such as a number of lanes, a number of other vehicles present, a width of the roadway, space available for a u-turn/multi-point turn, and/or the like) and wait for the blockage scene to be resolved. During the waiting period, the severity of the blockage can be recomputed and a new decision as to rerouting the vehicle can be made, e.g., at periodic time intervals. In some implementations, when the severity is below the threshold, but the waiting period is longer than some set time limit, router 244 can reroute the vehicle.

In some implementations, rerouting can be performed as follows. With the vehicle stopped, moving slowly (e.g., creeping forward), or pulled over to the side of the roadway, planner 242 can identify one or more starting waypoints for one or more alternative routes. For example, such starting waypoint(s) can include waypoints associated with one or more lanes in the current direction of travel of the vehicle, waypoints associated with one or more lanes traveling in the opposite direction, one or more lanes traveling perpendicularly to the current direction of travel or some other direction (e.g., crossing roads, side roads, and/or the like). Router 244 can then identify various possible routes connecting the alternative starting waypoints with the destination of the vehicle. Router 244 can also determine if at least one of the identified routes avoids the blockage, which can be confirmed using RA validation 360, in some implementations. If no such route is identified, the vehicle can remain at its current location (e.g., by the side of the road) until the driving environment changes or remote assistant 246 determines the route. If a suitable route is identified, router 244 can provide the identification of the preferred (one or more) alternative starting point(s) to planner 242, and planner 242 can identify one or more suitable driving maneuvers to reach the alternative starting point(s) from the current location of the vehicle, e.g., a turn, a u-turn, a multi-point turn, and/or the like. In some implementations, the maneuver(s) identified by planner 242 can undergo RA validation 360. If multiple maneuvers are identified, planner 242 can further select a maneuver that takes the least time to complete, a maneuver that is least disruptive to the traffic, and/or the using some other metrics. In some implementations, the maneuver can be selected (or validated) by the RA. Following the maneuver selection (and/or validation), planner 424 can determine if a clear path (e.g., a path that does not intersect predicted tracks of other objects) is available. If such a path is available, planner 424 can perform the selected maneuver to the alternative starting point and then follow a path to the target destination charted by router 244. If no such path is available (e.g., as a result of changing the driving environment), planner 424 can abstain from the selected maneuver and instead evaluate and select (and/or obtain RA validation 360) a different path. If no viable maneuver is identified, planner 242 can report this to remote assistant 246 and remain at its current location until the driving environment changes or until remote assistant 246 determines the route.

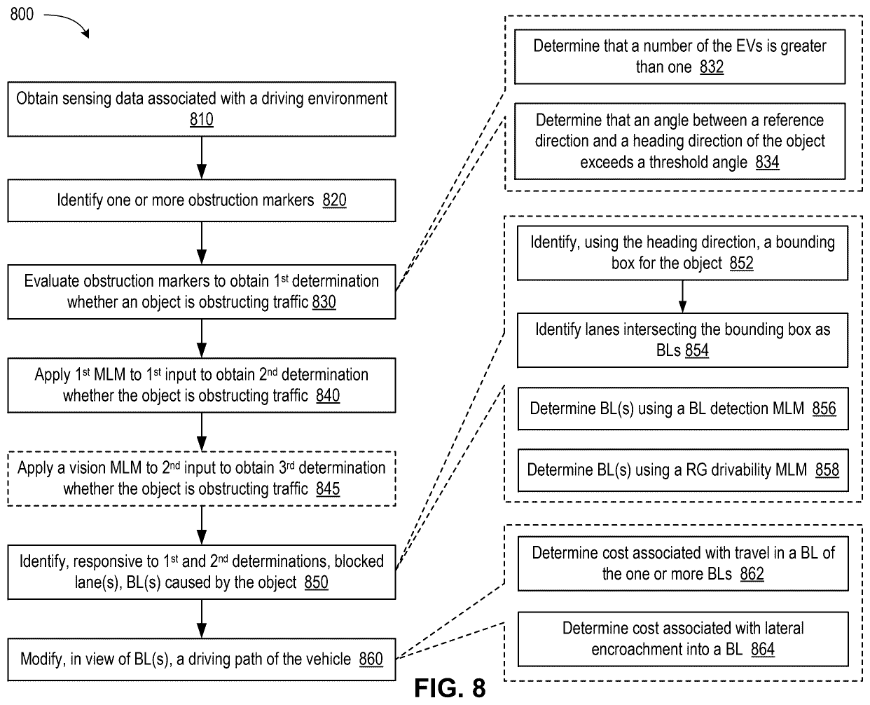

FIG. 8 illustrates an example method 800 of deploying a BL processing pipeline for identifying and navigating BLs in driving environments, in accordance with some implementations of the present disclosure. A processing device, having one or more processing units (CPUs), one or more graphics processing units (GPUs), one or more parallel processing units (PPUs) and memory devices communicatively coupled to the CPU(s), GPU(s), and/or PPU(s) can perform method 800 and/or each of its individual functions, routines, subroutines, or operations. Method 800 can be directed to systems and components of a vehicle. In some implementations, the vehicle can be an autonomous vehicle. In some implementations, the vehicle can be a driver-operated vehicle equipped with driver-assistance systems, e.g., Level 2 or Level 3 driver assistance systems, that provide limited assistance with specific vehicle systems (e.g., steering, braking, acceleration, etc. systems) or under limited driving conditions (e.g., highway driving). The processing device executing can perform instructions issued by the perception and planning system 130 of FIG. 1. In some implementations, a BL processing pipeline deployed using method 800 may be BL processing pipeline 132 of FIG. 1. In certain implementations, a single processing thread can perform method 800. Alternatively, two or more processing threads can perform method 800, each thread executing one or more individual functions, routines, subroutines, or operations of the method. In an illustrative example, the processing threads implementing method 800 can be synchronized (e.g., using semaphores, critical sections, and/or other thread synchronization mechanisms). Alternatively, the processing threads implementing method 800 can be executed asynchronously with respect to each other. Some operations of method 800 can be performed in a different order compared with the order shown in FIG. 8. Some operations of method 800 can be performed concurrently with other operations. Some operations can be optional.

At block 810, method 800 can include obtaining, using a sensing system of a vehicle, sensing data associated with a driving environment. The sensing data can include one or more camera images of the driving environment, one or more lidar images of the driving environment, and/or one or more radar images of the driving environment.

At block 820, method 800 can include processing, using a processing device, the sensing data to identify one or more obstruction markers associated with the driving environment. The one or more obstruction markers can include a heading direction of an object (or multiple objects) in the driving environment, a presence of one or more emergency vehicles (EVs) in the driving environment, a presence of one or more uniformed officers in the driving environment, a presence of one or more emergency signals in the driving environment, and/or the like.

At block 830, method 800 can include obtaining, using a processing device, a first determination whether an object, represented in the sensing data (e.g., object state 330 determined by object state heuristics module 222, with reference to FIG. 3), is obstructing traffic in the driving environment. The first determination may be based on the one or more obstruction markers. In some implementations, evaluating the one or more obstruction markers to obtain the first determination can include operations illustrated in the top callout portion in FIG. 8. More specifically, at block 832, operations of block 830 can include determining that a number of the one or more EVs in the driving environment is greater than one. At block 834, method 800 can include determining that an angle between a reference direction in the driving environment and the heading direction of the object exceeds a threshold angle.

At block 840, method 800 can include obtaining a second determination (e.g., object state 330 determined by block detection MLM 224, with reference to FIG. 3) whether the object is obstructing traffic in the driving environment by applying a first MLM (e.g., block detection MLM 224, with reference to FIGS. 2-4) to a first input including at least a portion of the sensing data. The first input can include at least a portion of the sensing data. In some implementations, e.g., as illustrated in FIG. 4, the first MLM can include an encoder neural network (NN) configured to process one or more roadgraph features representing a map of the driving environment, one or more traffic light features representing status of one or more traffic lights in the driving environment, and/or one or more object track features representing motion history of one or more objects in the driving environment. In some implementations, the first MLM can further include a decoder NN configured to process an output of the encoder NN and one or more classification heads configured to classify, using an output of the decoder NN, the one or more objects among a plurality of types associated with traffic obstruction.

In some implementations, at block 845, method 800 can include applying a vision MLM (e.g., VLM 226, with reference to FIGS. 2-3 and FIG. 5) to a second input to obtain a third determination whether the object is obstructing traffic in the driving environment. In some implementations, e.g., as illustrated in FIG. 5, the second input can include the one or more camera images of the driving environment, and one or more text tokens (e.g., generated by text encoder 550), each token associated with a corresponding type of one or more types of traffic obstruction.

At block 850, method 800 can continue with identifying, using the first determination and the second determination, one or more blocked lanes (BL) caused by the object. In some implementations, identifying the one or more BLs can include determining that, according to at least one of the first determination, the second determination, or a third determination (e.g., obtained using operations of block 856), the object is obstructing an individual lane in the driving environment. In some implementations, identifying the one or more BLs can include determining that, according to at least two of the first determination, the second determination, and/or the third determination, the object is obstructing an individual lane in the driving environment.

In some implementations, operations of block 850 include one or more operations illustrated with the middle callout portion of FIG. 8. More specifically, at block 852, identifying the one or more BLs can include identifying, using a heading direction of the object, a bounding box for the object. In some implementations, a size (e.g., length and/or width) of the bounding box can exceeds a size (e.g., length and/or width) of the object by a predetermined amount (e.g., 30%, 50%, 80%, 100%, and/or the like). At block 854, operations of block 850 can include identifying one or more lanes intersecting the bounding box as the one or more BLs.

At block 856, identifying the one or more BLs can include using BL detection MLM (e.g., as illustrated in FIG. 7). More specifically, operations of block 856 can include processing, using an encoder NN (e.g., scene encoder 710) of the BL detection MLM, a second input that includes one or more roadgraph features representing a map of the driving environment, one or more lane features, each representing an individual lane in the driving environment, and one or more blockage features representing presence of one or more blocking accessories in the driving environment. Operations can further include processing, using a decoder NN (e.g., lane decoder 720) of the BL detection MLM, a third input to generate an indication of the one or more BLs. The third input can include an output of the encoder NN, and the one or more lane features representing individual lanes in the driving environment.

As illustrated with block 858, identifying the one or more BLs can include using a roadgraph drivability MLM (e.g., RG drivability MLM 236 in FIGS. 2-3). More specifically, operations of block 858 can include obtaining a third determination that the object is obstructing traffic. The third determination can be obtained using a heatmap of probabilities, outputted by the roadgraph drivability MLM. In some implementations, an input into the roadgraph drivability MLM includes the sensing data, and a roadgraph information for the driving environment.

At block 860, method 800 can continue with modifying, in view of the one or more identified BLs, a driving path of the vehicle in the driving environment. In some implementations, operations of block 860 can include one or more operations illustrated with the bottom callout portion of FIG. 8. More specifically, at block 862, modifying the driving path of the vehicle can include determining a longitudinal cost associated with travel in at least one BL of the one or more BLs. The longitudinal cost can increase with decreased distance to a blocked portion of the one or more BLs. As illustrated with block 864, modifying the driving path of the vehicle can include determining a lateral cost associated with lateral encroachment, by the vehicle, into at least one BL of the one or more BLs. The driving path of the vehicle can be modified by minimizing or reducing the determined longitudinal cost and/or lateral cost. The driving path can be implemented by VCS 140 of FIG. 1.

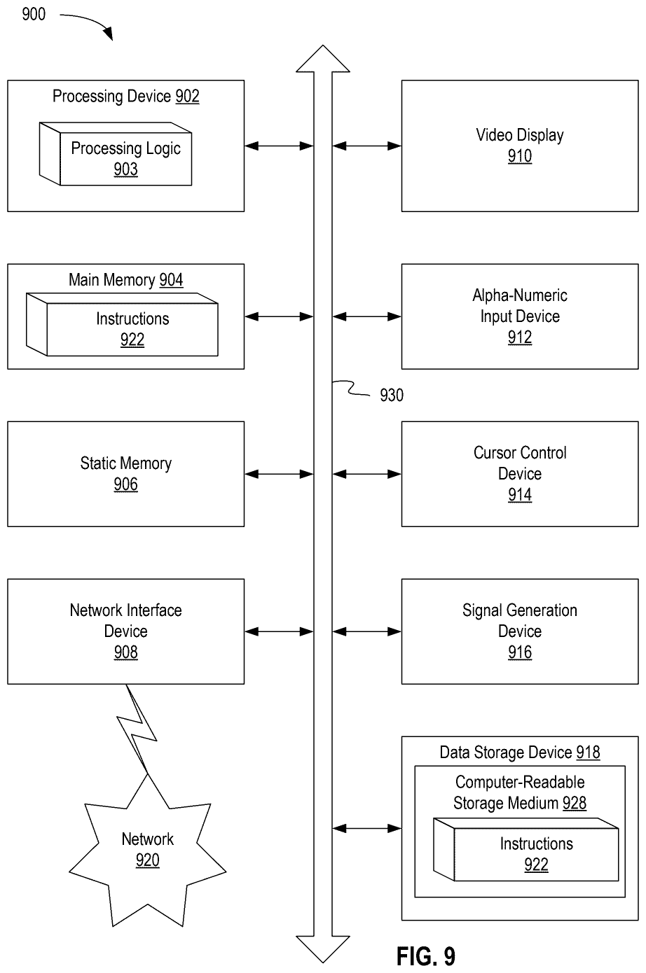

FIG. 9 depicts a block diagram of an example computer device 900 capable of a training and/or deploying a BL processing pipeline for identifying and navigating BLs in driving environments, in accordance with some implementations of the present disclosure. Example computer device 900 can be connected to other computer devices in a LAN, an intranet, an extranet, and/or the Internet. Computer device 900 can operate in the capacity of a server in a client-server network environment. Computer device 900 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 900 can include a processing device 902 (also referred to as a processor or CPU), a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 918), which can communicate with each other via a bus 930.

Processing device 902 (which can include processing logic 903) represents one or more general-purpose processing devices such as a microprocessor, central processing unit, or the like. More particularly, processing device 902 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 902 can be configured to execute instructions performing method 800 of deploying a BL processing pipeline for identifying and navigating BLs in driving environments.

Example computer device 900 can further include a network interface device 908, which can be communicatively coupled to a network 920. Example computer device 900 can further include a video display 910 (e.g., a liquid crystal display (LCD), a touch screen, or a cathode ray tube (CRT)), an alphanumeric input device 912 (e.g., a keyboard), a cursor control device 914 (e.g., a mouse), and an acoustic signal generation device 916 (e.g., a speaker).

Data storage device 918 can include a computer-readable storage medium (or, more specifically, a non-transitory computer-readable storage medium) 928 on which is stored one or more sets of executable instructions 922. In accordance with one or more aspects of the present disclosure, executable instructions 922 can include executable instructions performing method 800 of deploying a BL processing pipeline for identifying and navigating BLs in driving environments.

Executable instructions 922 can also reside, completely or at least partially, within main memory 904 and/or within processing device 902 during execution thereof by example computer device 900, main memory 904 and processing device 902 also constituting computer-readable storage media. Executable instructions 922 can further be transmitted or received over a network via network interface device 908.

While the computer-readable storage medium 928 is shown in FIG. 9 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A system comprising:
a sensing system of a vehicle, the sensing system configured to acquire sensing data associated with a driving environment;
a data processing system of the vehicle, the data processing system configured to:
identify one or more obstruction markers associated with the driving environment based on the sensing data;
obtain, based on the one or more obstruction markers, a first determination whether an object is obstructing traffic in the driving environment;
obtain a second determination whether the object is obstructing traffic in the driving environment by applying a first machine learning model (MLM) to a first input comprising at least a portion of the sensing data;
identify one or more blocked lanes caused by the object by using the first determination and the second determination; and
modify, in view of the one or more blocked lanes, a driving path of the vehicle in the driving environment.

2. The system of claim 1, wherein the one or more obstruction markers comprise one or more of:
a heading direction of the object,
a presence of one or more emergency vehicles (EVs) in the driving environment,
a presence of one or more uniformed officers in the driving environment, or
a presence of one or more emergency signals in the driving environment.

3. The system of claim 2, wherein to obtain the first determination, the data processing system is configured to determine that at least (i) a number of the one or more EVs in the driving environment is greater than one, or (ii) an angle between a reference direction in the driving environment and the heading direction of the object exceeds a threshold angle.

4. The system of claim 1, wherein the first MLM comprises:
an encoder neural network (NN) configured to process one or more of:
one or more roadgraph features representing a map of the driving environment;
one or more traffic light features representing status of one or more traffic lights in the driving environment; and
one or more object track features representing motion history of one or more objects in the driving environment; and
a decoder NN configured to process an output of the encoder NN; and
one or more classification heads configured to classify, using an output of the decoder NN, the one or more objects among a plurality of types associated with traffic obstruction.

5. The system of claim 1, wherein the sensing data comprises one or more camera images of the driving environment, and wherein the data processing system is further configured to:
obtain a third determination whether the object is obstructing traffic in the driving environment by applying a vision MLM to a second input to, wherein the second input comprises:
one or more camera images of the driving environment, and
one or more text tokens, each associated with a corresponding type of one or more types of traffic obstruction.

6. The system of claim 1, wherein to identify the one or more blocked lanes, the data processing system is configured to:
determine that, according to at least one of the first determination or the second determination, the object is obstructing an individual lane in the driving environment.

7. The system of claim 1, wherein to identify the one or more blocked lanes, the data processing system is configured to:
identify, using a heading direction of the object, a bounding box for the object, wherein a size of the bounding box exceeds a size of the object by a predetermined amount; and
identify one or more lanes intersecting the bounding box as the one or more blocked lanes.

8. The system of claim 1, wherein to identify the one or more blocked lanes, the data processing system is configured to:
process, using an encoder NN of a blocked lane detection MLM, a second input, wherein the second input comprises:
one or more roadgraph features representing a map of the driving environment;
one or more lane features, each representing an individual lane in the driving environment; and
one or more blockage features representing presence of one or more blocking accessories in the driving environment; and
generate an indication of the one or more blocked lanes by processing a third input using a decoder NN of the blocked lane detection MLM, wherein the third input comprises:
an output of the encoder NN, and
the one or more lane features representing individual lanes in the driving environment.

9. The system of claim 1, wherein to identify the one or more blocked lanes, the data processing system is further to use a third determination whether the object is obstructing traffic, wherein the third determination is obtained using a heatmap of probabilities, outputted by a roadgraph drivability MLM, wherein an input in the roadgraph drivability MLM comprises:
the sensing data, and
a roadgraph information for the driving environment.

10. The system of claim 1, wherein to modify the driving path of the vehicle, the data processing system is configured to:
determine a cost associated with travel in at least one blocked lane of the one or more blocked lanes, wherein the cost increases with decreased distance to a blocked portion of the one or more blocked lanes; and
modify the driving path of the vehicle in view of the determined cost.

11. The system of claim 1, wherein to modify the driving path of the vehicle, the data processing system is configured to:
determine a cost associated with lateral encroachment, by the vehicle, into at least one blocked lane of the one or more blocked lanes; and
modify the driving path of the vehicle in view of the determined cost.

12. A method comprising:
obtaining, using a sensing system of a vehicle, sensing data associated with a driving environment;
identifying, using a processing device, one or more obstruction markers associated with the driving environment based on the sensing data;
obtaining, using a processing device, a first determination whether an object, represented in the sensing data, is obstructing traffic in the driving environment, wherein the first determination is based on the one or more obstruction markers;
obtaining a second determination whether the object is obstructing traffic in the driving environment by applying a first machine learning model (MLM) to a first input comprising at least a portion of the sensing data;
identifying one or more blocked lanes caused by the object by using the first determination and the second determination; and
modifying, in view of the one or more blocked lanes, a driving path of the vehicle in the driving environment.

13. The method of claim 12, wherein the one or more obstruction markers comprise one or more of:
a heading direction of the object,
a presence of one or more emergency vehicles (EVs) in the driving environment,
a presence of one or more uniformed officers in the driving environment, or a presence of one or more emergency signals in the driving environment; and
wherein evaluating the one or more obstruction markers to obtain the first determination comprises at least one of:
determining that a number of the one or more EVs in the driving environment is greater than one, or
determining that an angle between a reference direction in the driving environment and the heading direction of the object exceeds a threshold angle.

14. The method of claim 12, wherein the first MLM comprises:
an encoder neural network (NN) configured to process one or more of:
one or more roadgraph features representing a map of the driving environment;
one or more traffic light features representing status of one or more traffic lights in the driving environment; and
one or more object track features representing motion history of one or more objects in the driving environment; and
a decoder NN configured to process an output of the encoder NN; and
one or more classification heads configured to classify, using an output of the decoder NN, the one or more objects among a plurality of types associated with traffic obstruction.

15. The method of claim 12, wherein the sensing data comprises one or more camera images of the driving environment, the method further comprising:
obtaining a third determination whether the object is obstructing traffic in the driving environment by applying a vision MLM to a second input, wherein the second input comprises:
the one or more camera images of the driving environment, and
one or more text tokens, each associated with a corresponding type of one or more types of traffic obstruction.

16. The method of claim 12, wherein identifying the one or more blocked lanes comprises:
identifying, using a heading direction of the object, a bounding box for the object, wherein a size of the bounding box exceeds a size of the object by a predetermined amount; and
identifying one or more lanes intersecting the bounding box as the one or more blocked lanes.

17. The method of claim 12, wherein identifying the one or more blocked lanes comprises:
processing, using an encoder NN of a blocked lane detection MLM, a second input, wherein the second input comprises:
one or more roadgraph features representing a map of the driving environment;
one or more lane features, each representing an individual lane in the driving environment; and
one or more blockage features representing presence of one or more blocking accessories in the driving environment; and
generating an indication of the one or more blocked lanes by processing, using a decoder NN of the blocked lane detection MLM, a third input, wherein the third input comprises:
an output of the encoder NN, and
the one or more lane features representing individual lanes in the driving environment.

18. The method of claim 12, wherein identifying the one or more blocked lanes comprises using a third determination whether the object is obstructing traffic, wherein the third determination is obtained using a heatmap of probabilities, outputted by a roadgraph drivability MLM, wherein an input in the roadgraph drivability MLM comprises:
the sensing data, and
a roadgraph information for the driving environment.

19. The method of claim 12, wherein modifying the driving path of the vehicle comprises:
determining a cost associated with travel in at least one blocked lane of the one or more blocked lanes, wherein the cost comprises at least one of:
a first cost increases with decreased distance to a blocked portion of the one or more blocked lanes; or
a second cost associated with lateral encroachment, by the vehicle, into at least one blocked lane of the one or more blocked lanes; and
modifying the driving path of the vehicle in view of the determined cost.

20. An autonomous vehicle comprising:
a sensing system configured to acquire sensing data associated with a driving environment, the sensing data comprising one or more of:
one or more camera images of the driving environment,
one or more lidar images of the driving environment, or
one or more radar images of the driving environment;
a data processing system configured to:
identify one or more obstruction markers associated with the driving environment based on the sensing data;
obtain, based on the one or more obstruction markers, a first determination whether an object, represented in the sensing data, is obstructing traffic in the driving environment;
obtain a second determination whether the object is obstructing traffic in the driving environment by applying a first machine learning model (MLM) to a first input comprising at least a portion of the sensing data;
identify one or more blocked lanes caused by the object by using the first determination and the second determination; and
modify, in view of the one or more blocked lanes, a driving path of the vehicle in the driving environment; and
a driving control system configured to:
direct the autonomous vehicle on the modified driving path.
